(19) United States
(12) Patent Application Publication
(10) Pub. No.: US 2026/0295784 A1
(43) Pub. Date: Oct. 1, 2026

(54) ELECTRIC TOOL

(71) Applicant: MAKITA CORPORATION, Anjo-shi (JP)

(72) Inventors: Yuta SUZUKI, Anjo-shi (JP); Tomoro AOYAMA, Anjo-shi (JP); Yuya OKADA, Anjo-shi (JP)

(73) Assignee: MAKITA CORPORATION, Anjo-shi (JP)

(21) Appl. No.: 19/633,146

(22) Filed: Mar. 30, 2026

(30) Foreign Application Priority Data
Mar. 28, 2025 (JP) 2025-055776
Mar. 28, 2025 (JP) 2025-055777

(51) Int. Cl. B25B 21/02; B25F 5/02

(52) U.S. Cl. CPC B25B 21/02; B25F 5/026

(57) ABSTRACT

An electric tool includes a resin housing and a metallic casing. The resin housing includes a motor containing portion, a battery holding portion, and a handle portion extending elongatedly in a direction generally orthogonal to a front-rear direction between the motor containing portion and the battery holding portion. The metallic casing is located on a front side of the motor containing portion. The metallic casing includes a tubular portion and a protrusion portion. The tubular portion has a tubular shape extending in the front-rear direction in communication with an inside of the motor containing portion. The tubular portion contains a part of a final output shaft and at least a part of a power transmission mechanism therein. The tubular portion is coupled with the motor containing portion by threaded joining. The protrusion portion protrudes from the tubular portion radially outward. The protrusion portion includes a second engagement portion engaged with a first engagement portion of the resin housing on the front side with respect to a coupling position between the motor containing portion and the tubular portion. The second engagement portion is located on a lower side with respect to the first engagement portion.

### TECHNICAL FIELD

The present disclosure relates to an electric tool.

### BACKGROUND

As one type of electric tool, impact wrenches are known. For example, an impact wrench described in Japanese Patent Application Laid-Open No. 2025-33535 includes a metallic casing (also referred to as a hammer case) containing a proximal end portion of an anvil, and a resin housing. The resin housing includes an elongated handle portion, a motor containing portion connected to one end of the handle portion, and a battery holding portion connected to the other end of the handle portion. The metallic casing is coupled with the motor containing portion. The metallic casing and the motor containing portion are coupled by threaded joining.

### SUMMARY

The present specification discloses an electric tool. This electric tool may include a motor, a rotatable final output shaft, a power transmission mechanism operably coupled with the motor and configured to transmit a rotational driving force of the motor to the final output shaft, a resin housing, and a metallic casing. The resin housing may include a motor containing portion, a battery holding portion, and a handle portion. The motor containing portion may have a tubular shape extending in a front-rear direction when the front-rear direction is defined to be an axial direction of the final output shaft and a front side and a rear side are defined to a side in the front-rear direction on which the final output shaft is located and a side opposite from the final output shaft, respectively. The motor containing portion may contain the motor therein. The battery holding portion may hold a detachable battery serving as a power source of the motor. The handle portion may extend elongatedly in a direction generally orthogonal to the front-rear direction between the motor containing portion and the battery holding portion. The metallic casing may be located on the front side of the motor containing portion. The metallic casing may include a tubular portion and a protrusion portion. The tubular portion may have a tubular shape extending in the front-rear direction in communication with an inside of the motor containing portion. The tubular portion may contain a part of the final output shaft and at least a part of the power transmission mechanism therein. The tubular portion may be coupled with the motor containing portion by threaded joining. The protrusion portion may protrude from the tubular portion radially outward. When a up-down direction is defined to be a direction orthogonal to the front-rear direction and generally parallel with a longitudinal direction of the handle portion and an upper side and a lower side are defined to be a side in the up-down direction on which the motor containing portion is located and a side in the up-down direction on which the battery holding portion is located, respectively, the protrusion portion may include a second engagement portion engaged with a first engagement portion of the resin housing on the front side with respect to a coupling position between the motor containing portion and the tubular portion. The second engagement portion may be located on the lower side with respect to the first engagement portion.

According to this electric tool, even when a user accidentally drops the electric tool and the electric tool hits the ground or the like while landing on the motor containing portion, and moments in opposite directions are respectively applied to the battery and the motor containing portion, the first engagement portion and the second engagement portion can withstand a force applied in a direction for breaking the threaded joint portion between the tubular portion of the metallic casing and the motor containing portion (hereinafter referred to as a drop-time applied force). Therefore, the threaded joint portion between the tubular portion of the metallic casing and the motor containing portion is less prone to damage.

### BRIEF DESCRIPTION OF THE DRAWINGS

FIG. 1 is a perspective view of an impact wrench according to a first embodiment.

FIG. 2 is a perspective view of the impact wrench.

FIG. 3 is a front view of the impact wrench.

FIG. 4 is a left side view of the impact wrench.

FIG. 5 is a cross-sectional view of the impact wrench taken along a line A-A illustrated in FIG. 3.

FIG. 6 is a right side view of a right portion of a housing.

FIG. 7 is a perspective view of a hammer case.

FIG. 8 is a right side view of the hammer case.

FIG. 9 is a partial cross-sectional view of the impact wrench taken along a line B-B illustrated in FIG. 4.

FIG. 10 is a partial enlarged view of FIG. 9.

FIG. 11 is a partial cross-sectional view of the impact wrench taken along a line C-C illustrated in FIG. 4.

FIG. 12 is a partial enlarged view of FIG. 11.

FIG. 13 illustrates moments applied when the impact wrench is dropped.

FIG. 14 is a right side view of an impact wrench according to a second embodiment.

FIG. 15 is a perspective view of a hammer case according to the second embodiment.

FIG. 16 is a partial cross-sectional view of the impact wrench according to the second embodiment, and corresponds to FIG. 9.

FIG. 17 is a partial enlarged view of FIG. 16.

FIG. 18 is a perspective view of an impact wrench according to a third embodiment.

FIG. 19 is a perspective view of the impact wrench.

FIG. 20 is a front view of the impact wrench.

FIG. 21 is a left side view of the impact wrench.

FIG. 22 is a cross-sectional view of the impact wrench taken along a line D-D illustrated in FIG. 20.

FIG. 23 is a partial enlarged view of FIG. 22.

FIG. 24 is a right side view of the impact wrench and a bumper with a protective cover removed.

FIG. 25 is a perspective view of the impact wrench and the bumper with the protective cover removed.

FIG. 26 is a partial cross-sectional view of the impact wrench taken along a line E-E illustrated in FIG. 21.

FIG. 27 is a partial cross-sectional view of the impact wrench taken along a line F-F illustrated in FIG. 21.

FIG. 28 is a perspective view of the bumper.

FIG. 29 is a perspective view of the bumper.

FIG. 30 is a right side view of the hammer case.

FIG. 31 is a perspective view of a bumper according to a fourth embodiment with a protective cover removed.

FIG. 32 is a partial cross-sectional view of the impact wrench according to the fourth embodiment, and corresponds to FIG. 26.

FIG. 33 is a perspective view of the bumper according to the fourth embodiment.

### DETAILED DESCRIPTION OF THE EMBODIMENTS

In the following description, representative and non-limiting specific examples of the present invention will be described in detail with reference to the drawings. This detailed description is merely intended to teach a person of skill in the art details for practicing preferred examples of the present invention and is not intended to limit the scope of the present invention. Furthermore, each of additional features and inventions disclosed below can be utilized separately from or together with other features and inventions to provide further improved apparatuses and methods for manufacturing and using the same.

Moreover, combinations of features and steps disclosed in the following detailed description are not necessary to practice the present invention in the broadest sense, and are instead taught merely to particularly describe a representative specific example of the present invention. Furthermore, various features of the above-described and the following representative examples, as well as various features recited in the independent and dependent claims below, do not necessarily have to be combined in herein specifically exemplified manners or enumerated orders to provide additional and useful embodiments of the present invention.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges and indications of groups or aggregations are intended to disclose every possible intermediate individual forming them for the purpose of original written disclosure, as well as for the purpose of restricting the claimed subject matter.

In one or more embodiments, the protrusion portion may include a base portion protruding from a lowest portion of the tubular portion downward, and an intersection-direction extending portion extending from the base portion in a direction intersecting with the up-down direction and including the second engagement portion. According to this configuration, the size of the electric tool can be reduced in a direction intersecting with the front-rear direction and the up-down direction.

In one or more embodiments, the intersection-direction extending portion may extend in a direction orthogonal to the up-down direction. At least a part of an upper surface of the intersection-direction extending portion may function as the second engagement portion. According to this configuration, the metallic casing and the resin housing can be easily positioned, which thus facilitates manufacturing of the electric tool.

In one or more embodiments, when a left-right direction is defined to be a direction orthogonal to the front-rear direction and the up-down direction, the intersection-direction extending portion may extend from the base portion rightward and leftward. According to this configuration, the first engagement portion and the second engagement portion can receive the drop-time applied force in a well-balanced manner between the left side and the right side. Therefore, the present configuration makes the threaded joint portion between the tubular portion of the metallic casing and the motor containing portion even less prone to damage.

In one or more embodiments, the resin housing may include a recessed portion sized and shaped in conformity with the intersection-direction extending portion and configured in such a manner that the intersection-direction extending portion is contained in the recessed portion. At least a part of a surface facing downward, among inner surfaces of the resin housing that define the recessed portion, may function as the first engagement portion. According to this configuration, the metallic casing and the resin housing can be easily positioned. Further, this configuration can eliminate or reduce the occurrence of rattling between the metallic casing and the resin housing.

In one or more embodiments, the first engagement portion and the second engagement portion may be engaged in surface contact with each other. According to this configuration, the first engagement portion and the second engagement portion can stably receive the drop-time applied force over a wider area compared with point contact or linear contact.

In one or more embodiments, the second engagement portion may be located at a position corresponding to a front half of the metallic casing in the front-rear direction. According to this configuration, the engagement point between the first engagement portion and the second engagement portion can be located away from the threaded joint portion between the tubular portion of the metallic casing and the motor containing portion, and this leads to an increase in a moment in a direction for receiving the drop-time applied force. Therefore, the present configuration can reduce a load that should be received by the first engagement portion and the second engagement portion at the time of a drop.

In one or more embodiments, the resin housing may further include a support rod portion located on the front side with respect to the handle portion and extending elongatedly generally in parallel with the handle portion between the battery holding portion and the metallic casing. The first engagement portion may be located at a distal end portion of the support rod portion opposite from the battery holding portion. According to this configuration, the durability of the electric tool at the time of a drop can be improved. In other words, the present configuration allows the electric tool to have a large size. Further, the present configuration can ensure that the first engagement portion is located on a further front side by utilizing the support rod portion. Therefore, the present configuration can reduce a load that should be received by the first engagement portion and the second engagement portion at the time of a drop.

In one or more embodiments, the first engagement portion may include a front first engagement portion, and a rear first engagement portion spaced apart from the front first engagement portion in the front-rear direction and located on the rear side with respect to the front first engagement portion. The second engagement portion may include a front second engagement portion and a rear second engagement portion. The front second engagement portion may be engaged with the front first engagement portion. The rear second engagement portion may be spaced apart from the front second engagement portion in the front-rear direction, located on the rear side with respect to the front second engagement portion, and engaged with the rear first engagement portion. According to this configuration, the first engagement portion and the second engagement portion can receive the drop-time applied force at two portions spaced apart in the front-rear direction. In other words, the electric tool receives the drop-time applied force at a larger number of portions. Therefore, the present configuration makes the threaded joint portion between the tubular portion of the metallic casing and the motor containing portion even less prone to damage.

In one or more embodiments, the first engagement portion may include an upper first engagement portion, and a lower first engagement portion spaced apart from the upper first engagement portion in the up-down direction and located on the lower side with respect to the upper first engagement portion. The intersection-direction extending portion may include an upper second engagement portion and a lower second engagement portion. The upper second engagement portion may be engaged with the upper first engagement portion. The lower second engagement portion may be spaced apart from the upper second engagement portion in the up-down direction, located on the lower side with respect to the upper second engagement portion, and engaged with the lower first engagement portion. According to this configuration, the first engagement portion and the second engagement portion can receive the drop-time applied force at two portions spaced apart in the up-down direction. In other words, the electric tool receives the drop-time applied force at a larger number of portions. Therefore, the present configuration makes the threaded joint portion between the tubular portion of the metallic casing and the motor containing portion even less prone to damage.

In one or more embodiments, the resin housing may have a half-divided structure dividable into a right portion and a left portion in a direction orthogonal to the front-rear direction and the up-down direction. The electric tool may include a plurality of screws that join the right portion and the left portion together. Each of the plurality of screws may join the right portion and the left portion together without penetrating through the protrusion portion. According to this configuration, the drop-time applied force is not applied to any of the plurality of screws. Therefore, the present configuration eliminates the necessity of designing some of the plurality of screws according to specifications capable of withstanding the drop-time applied force. In other words, the plurality of screws can be designed according to common specifications, and the electric tool can be manufactured with less time and labor.

In one or more embodiments, the resin housing may have a half-divided structure dividable into a right portion and a left portion in a direction orthogonal to the front-rear direction and the up-down direction. The electric tool may include a plurality of screws that join the right portion and the left portion together. At least one of the plurality of screws may join the right portion and the left portion together in a state of penetrating through the protrusion portion. According to this configuration, the screw penetrating through the protrusion portion can also receive the drop-time applied force in addition to the first engagement portion and the second engagement portion. Therefore, the present configuration makes the threaded joint portion between the tubular portion of the metallic casing and the motor containing portion even less prone to damage.

The present specification discloses an electric tool. This electric tool may include a motor, a final output shaft rotatable about a rotational axis, a power transmission mechanism operably coupled with the motor and configured to transmit a rotational driving force of the motor to the final output shaft, a metallic casing, a protective cover, and a resin housing. The metallic casing may have a tubular shape extending in an axial direction, which is a direction in which the rotational axis extends, and contain a part of the final output shaft and at least a part of the power transmission mechanism therein. The protective cover may be elastic, and cover a portion of the metallic casing that is located on a front side around the rotational axis, when a front-rear direction is defined to be the axial direction and the front side and a rear side are defined to a side in the front-rear direction on which the final output shaft is located and a side opposite from the final output shaft, respectively, The protective cover may be detachably attached to the metallic casing from the front side. The resin housing may be located adjacent to the metallic casing in a direction orthogonal to the axial direction. The protective cover may include an annular portion and a protrusion portion. The annular portion may include a first engagement portion configured to be detachably engaged with the metallic casing using elasticity of the protective cover, and cover the metallic casing around the rotational axis. The protrusion portion may include a second engagement portion configured to be detachably engaged with the resin housing using the elasticity of the protective cover, and protrude from the annular portion radially outward. A hammer case 230, which will be described below, is non-limiting one example of the “metallic casing”. A first bumper 260, which will be described below, is non-limiting one example of the “protective cover”. A support rod portion 53, which will be described below, is non-limiting one example of the “resin housing”.

According to this electric tool, the protective cover is engaged with the resin housing adjacent to the metallic casing in the direction orthogonal to the axial direction, in addition to the metallic casing. Therefore, it is possible to eliminate or reduce or the possibility of unintended detachment of the protective cover compared with a configuration in which the protective cover is engaged only with the metallic casing.

In one or more embodiments, the resin housing may include a hole portion. The second engagement portion may include a protrusion inserted in the hole portion and engaged with an inner surface of the resin housing that defines the hole portion. According to this configuration, the protective cover can be easily attached and detached by an operation of pushing the protrusion of the second engagement portion into the hole of the resin housing and an operation of pulling out the protrusion of the second engagement portion from the hole of the resin housing. A threaded boss 356a, a hole portion 355, and a hole portion 455, which will be described below, are non-limiting one example of the “hole portion”.

In one or more embodiments, the hole portion may include a small-diameter hole portion having a first inner diameter, and a large-diameter hole portion having a second inner diameter larger than the first inner diameter and continuous to the small-diameter hole portion on an inner side of the resin housing with respect to the small-diameter hole portion. The protrusion may include a shaft portion having an outer diameter smaller than the first inner diameter, and a head portion having an outer diameter larger than the first inner diameter and smaller than the second inner diameter and located at a distal end of the shaft portion. The head portion of the protrusion that is inserted in the large-diameter hole portion may be engaged with a stepped portion between the small-diameter hole portion and the large-diameter hole portion so as to be prevented from slipping off from the hole portion. According to this configuration, the protrusion of the second engagement portion of the protective cover can be securely engaged with the hole portion of the resin housing. Therefore, the possibility of the unintended detachment of the protective cover can be further effectively eliminated or reduced.

In one or more embodiments, the resin housing may have a half-divided structure dividable into a first portion and a second portion. The hole portion may include a threaded boss in which a screw for joining the first portion and the second portion together is inserted. According to this configuration, the threaded boss provided for the purpose of joining the first portion and the second portion of the resin housing together is also usable as the hole portion for engagement with the protective cover. Therefore, the resin housing can be simply structured compared with a configuration in which the hole portion is provided separately from the threaded boss. The threaded boss 356a, which will be described below, is non-limiting one example of the “threaded boss”.

In one or more embodiments, the metallic casing may include a first outer-diameter portion having a first outer diameter, a second outer-diameter portion located on the front side with respect to the first outer-diameter portion and having a second outer diameter smaller than the first outer diameter, and an annular groove portion located between the first outer-diameter portion and the second outer-diameter portion. The annular groove portion may include a bottom portion, a plurality of first protrusion portions protruding from the bottom portion radially outward and arranged at intervals along a circumferential direction. A top portion of each of the first protrusion portions may be located on a radially inner side with respect to an outer circumferential portion of the second outer-diameter portion. The first engagement portion may include a plurality of second protrusion portions arranged at intervals in the circumferential direction. The plurality of second protrusion portions may be respectively inserted in a plurality of recessed portions defined between the plurality of first protrusion portions in conformity therewith due to elastic deformation, and engaged with inner surfaces defining the plurality of recessed portions so as to be prevented from slipping off from the plurality of recessed portions. The annular portion is sandwiched between the first outer-diameter portion and the second outer-diameter portion in the front-rear direction with the plurality of second protrusion portions respectively inserted in the plurality of recessed portions. According to this configuration, the metallic casing and the protective cover are engaged due to the annular portion sandwiched between the first outer-diameter portion and the second outer-diameter portion in the front-rear direction in addition to the engagement based on the plurality of second protrusion portions. Further, the annular portion of the protective cover is deeply fitted in the annular groove portion between the first outer-diameter portion and the second outer-diameter portion even at a circumferential position where the second protrusion portion is absent. Therefore, the engagement force is enhanced and the possibility of the unintended detachment of the protective cover can be further effectively eliminated or reduced.

In one or more embodiments, the resin housing may include a battery holding portion configured to hold a detachable battery serving as a power source of the motor, a handle located between the battery holding portion and the metallic casing in a direction orthogonal to the axial direction and extending elongatedly in a direction generally orthogonal to the axial direction, and a support rod portion located on the front side with respect to the handle and extending elongatedly generally in parallel with the handle between the battery holding portion and the metallic casing. The second engagement portion may be engaged with the support rod portion.

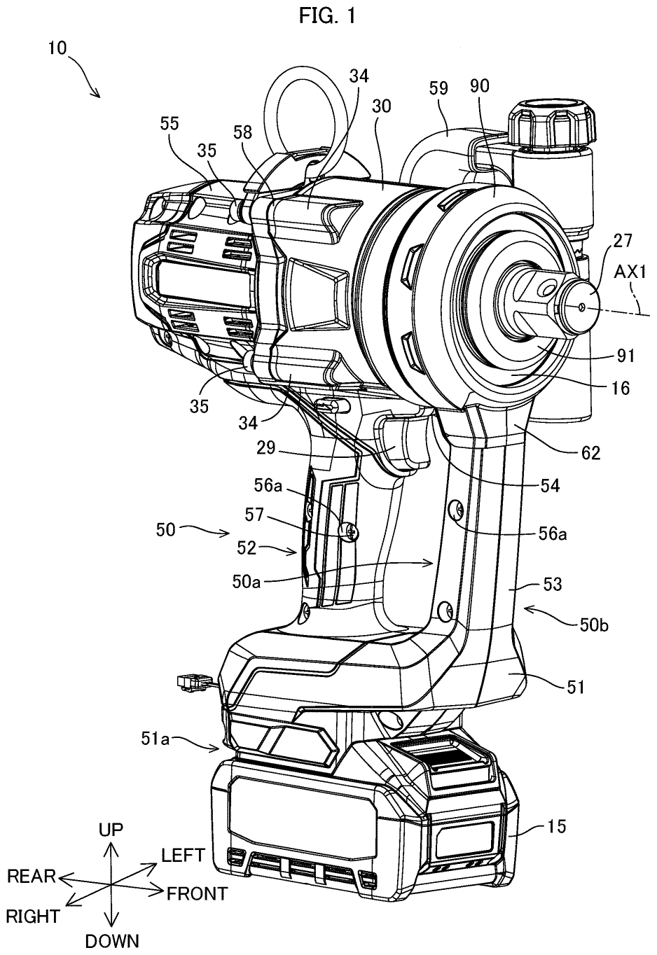

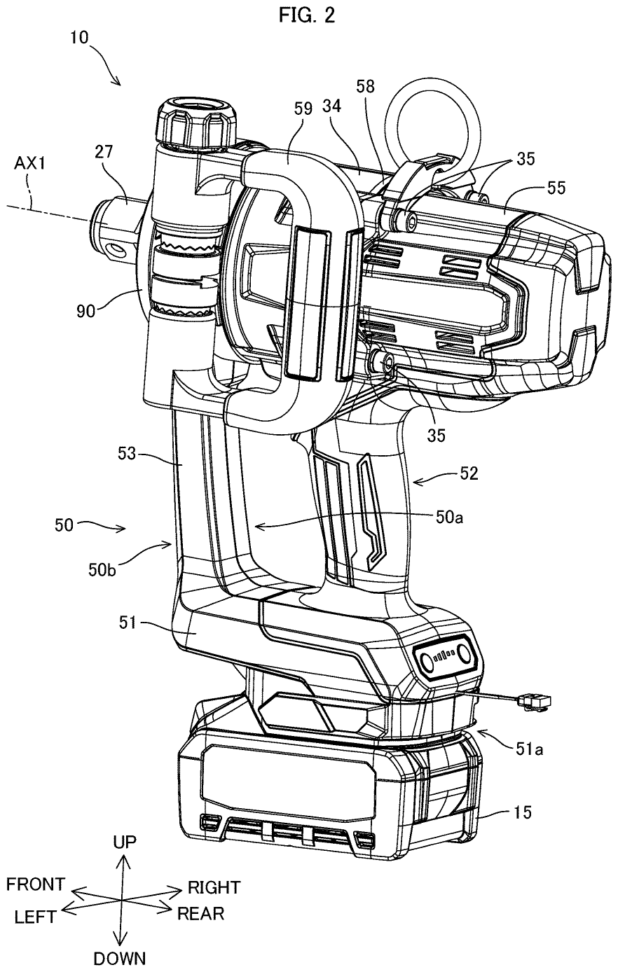

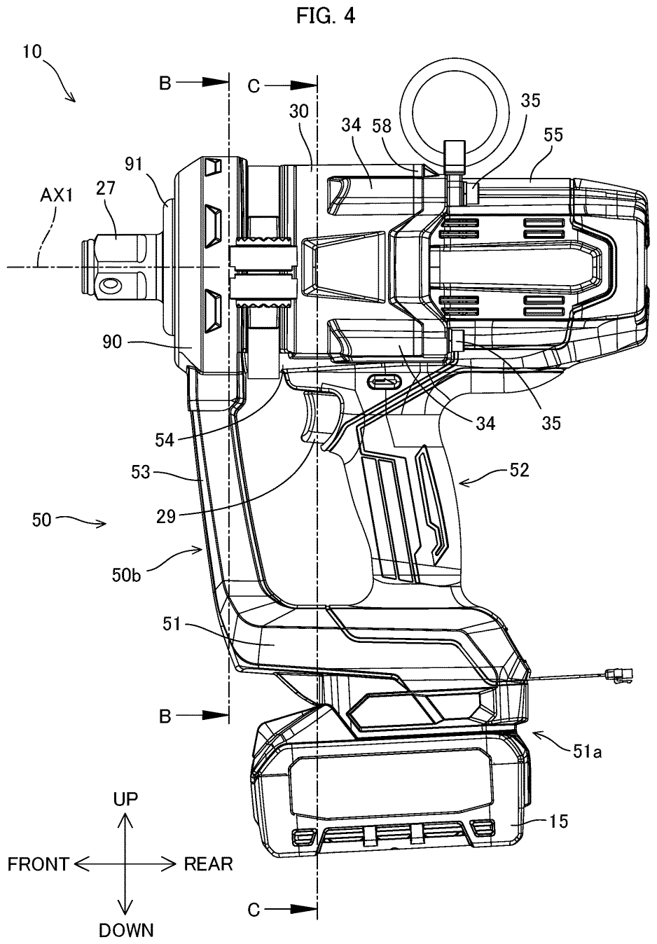

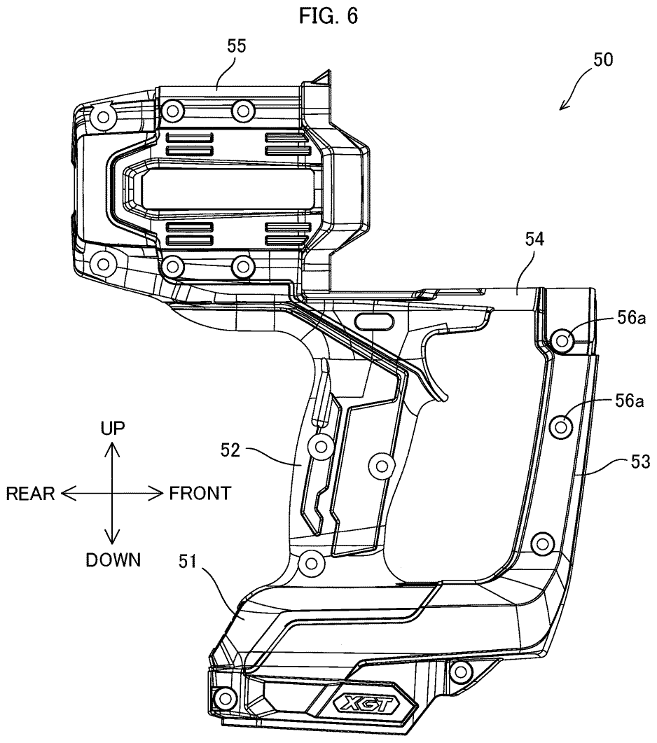

In the following description, an impact wrench 10 according to a representative and non-limiting first embodiment of the present disclosure will be described more specifically with reference to FIGS. 1 to 13. As illustrated in FIGS. 1 to 5, the impact wrench 10 includes a metallic hammer case 30 and a resin housing 50. As illustrated in FIG. 6, the housing 50 includes a battery holding portion 51, a handle portion 52, a support rod portion 53, a coupling portion 54, and a motor containing portion 55.

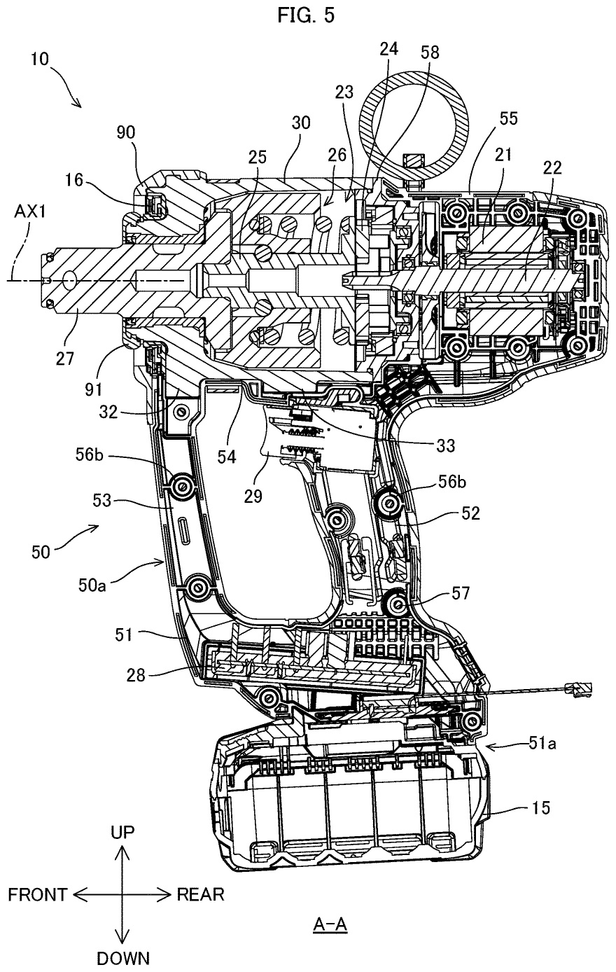

As illustrated in FIG. 5, the motor containing portion 55 is tubularly shaped, and a motor 21 including a motor shaft 22 is contained in the motor containing portion 55. A power transmission mechanism 23 is operably coupled with the motor shaft 22. The power transmission mechanism 23 transmits a rotational driving force of the motor 21 to an anvil 27 serving as a final output shaft. Due to that, the anvil 27 is rotatable about a rotational axis AX1. The rotational axis AX1 is coaxial with the motor shaft 22, and coincides with the central axis of the anvil 27. The power transmission mechanism 23 includes a speed reduction mechanism 24, a spindle 25, and an impact mechanism 26. An impact force in a rotational direction is provided to the anvil 27 with the aid of the impact mechanism 26. Such a mechanical configuration of the impact wrench 10 is well-known, and therefore a detailed description thereof will be omitted herein.

As illustrated in FIG. 5, a gear case 58 holding the speed reduction mechanism 24 is disposed adjacent to the motor containing portion 55 in front of the motor containing portion 55. The hammer case 30 is disposed adjacent to the gear case 58 in front of the gear case 58. The hammer case 30 has a tubular shape extending in the axial direction of the anvil 27 (a direction in which the rotational axis AX1 extends), and the inside thereof is in communication with the inside of the motor containing portion 55. The spindle 25 and the impact mechanism 26 are contained in the hammer case 30. Further, the anvil 27 is partially contained in the hammer case 30. The distal end of the anvil 27 is exposed from the hammer case 30.

As illustrated in FIGS. 1 to 5, the handle portion 52 extends elongatedly in a direction intersecting with (more specifically, generally orthogonal to) the rotational axis AX1 between the motor containing portion 55 and the battery holding portion 51. The handle portion 52 is a portion held by a user when the impact wrench 10 is in use. The battery holding portion 51 includes a battery mount portion 51a at the edge portion opposite from the handle portion 52. The battery mount portion 51a includes an interface for electrically connecting to a battery 15 serving as an electric power source of the impact wrench 10 and an interface for mechanically connecting to the battery 15, and is configured to allow the battery 15 to be detachably mounted thereto. The battery holding portion 51 holds the battery 15 mounted on the battery mount portion 51a.

In the following description, a front-rear direction of the impact wrench 10 is defined to be the direction in which the rotational axis AX1 extends for convenience of the description. A front side and a rear side of the impact wrench 10 are defined to be a side in the front-rear direction on which the anvil 27 is located, and the opposite side therefrom, respectively. Further, a up-down direction of the impact wrench 10 is defined to be a direction orthogonal to the rotational axis AX1 and generally parallel with the direction in which the handle portion 52 extends (i.e., the longitudinal direction of the handle portion 52). An upper side and a lower side of the impact wrench 10 are defined to be a side in the up-down direction on which the motor containing portion 55 (or the hammer case 30) is located and a side in the up-down direction on which the battery holding portion 51 is located, respectively. Further, a left-right direction of the impact wrench 10 is defined to be a direction orthogonal to the front-rear direction and the up-down direction. A right side and a left side of the impact wrench 10 are defined to be a right side in the left-right direction when the front side is viewed from the rear side, and the opposite side therefrom, respectively.

As illustrated in FIGS. 1 to 5, a trigger 29 is provided at the upper and front portion of the handle portion 52. The trigger 29 is used to perform an operation of starting up and stopping the motor 21. As illustrated in FIG. 5, a controller 28 is contained in the battery holding portion 51. The controller 28 supplies electric power of the battery 15 to the motor 21 and controls the operation of the motor 21.

As illustrated in FIGS. 1 to 6, the handle portion 52 extends upward from near the rear edge portion of the battery holding portion 51. The upper and rear edge portion of the handle portion 52 is continuous to the motor containing potion 55. The support rod portion 53 is located on the front side with respect to the handle portion 52, and extends elongatedly generally in parallel with the handle portion 52 between the front edge portion of the battery holding portion 51 and the hammer case 30. In other words, the support rod portion 53 is adjacent to the hammer case 30 in the up-down direction. The coupling portion 54 extends in the front-rear direction, and connects the upper end of the support rod portion 53 and the upper end of the handle portion 52 below the hammer case 30.

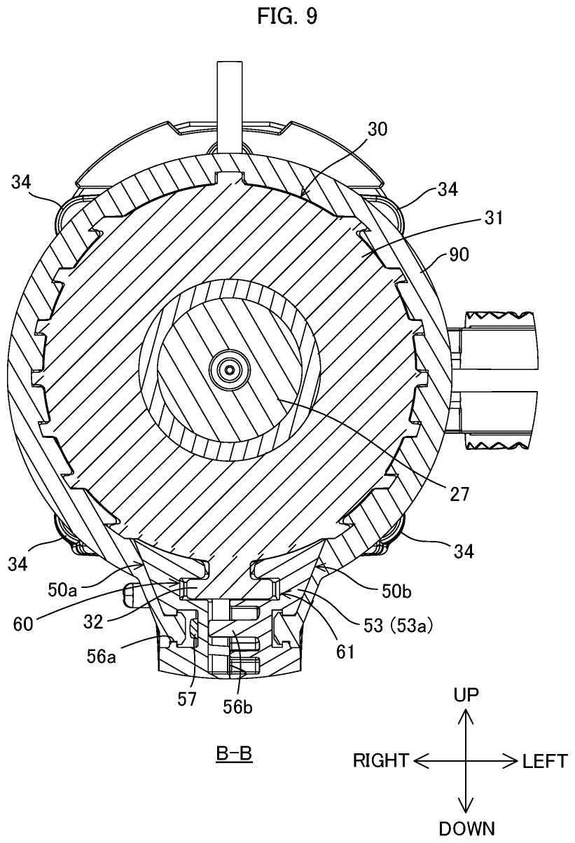

As illustrated in FIGS. 1 to 4, the housing 50 has a half-divided structure dividable into a right portion 50a and a left portion 50b in the left-right direction in the present embodiment. Each of the right portion 50a and the left portion 50b is an integrated molded member. As illustrated in FIGS. 1 and 6, the right portion 50a includes a plurality of treaded bosses 56a. The threaded bosses 56a are opened rightward. The left portion 50b also includes, inside the left portion 50b, a plurality of threaded bosses 56b (refer to FIGS. 5 and 9) opened rightward at positions corresponding to the plurality of threaded bosses 56a of the right portion 50a. The right portion 50a and the left portion 50b are integrated together by a plurality of screws 57 respectively inserted in the plurality of threaded bosses 56a and the plurality of threaded bosses 56b.

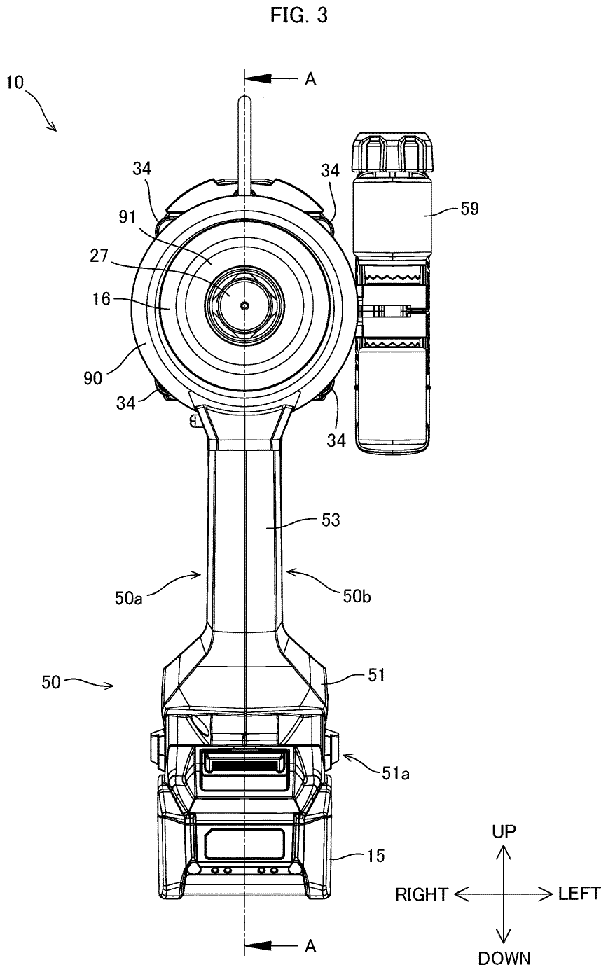

As illustrated in FIGS. 1 to 3, a side handle 59 is attachable to the impact wrench 10. The side handle 59 is removed in the drawings other than FIGS. 1 to 3. As illustrated in FIGS. 1 and 3, an annular illumination unit 16 is disposed on the front side of the hammer case 30. The illumination unit 16 includes a plurality of LEDs distributed in a circumferential direction with respect to the rotational axis AX1. The illumination unit 16 emits light forward when the impact wrench 10 is in use.

As illustrated in FIGS. 1 to 5, a first bumper 90 and a second bumper 91 as protective covers are attached to the hammer case 30. The first bumper 90 and the second bumper 91 are made of elastic materials. In the present embodiment, the first bumper 90 and the second bumper 91 are made of rubber. The first bumper 90 is detachably attached to the hammer case 30 and an upper end portion 53a of the support rod portion 53 from the front side. The first bumper 90 covers a portion of the hammer case 30 that is located on the front side around the rotational axis AX1. The second bumper 91 is detachably attached to the front edge portion of the hammer case 30. The second bumper 91 covers the front edge portion of the hammer case 30 around the rotational axis AX1.

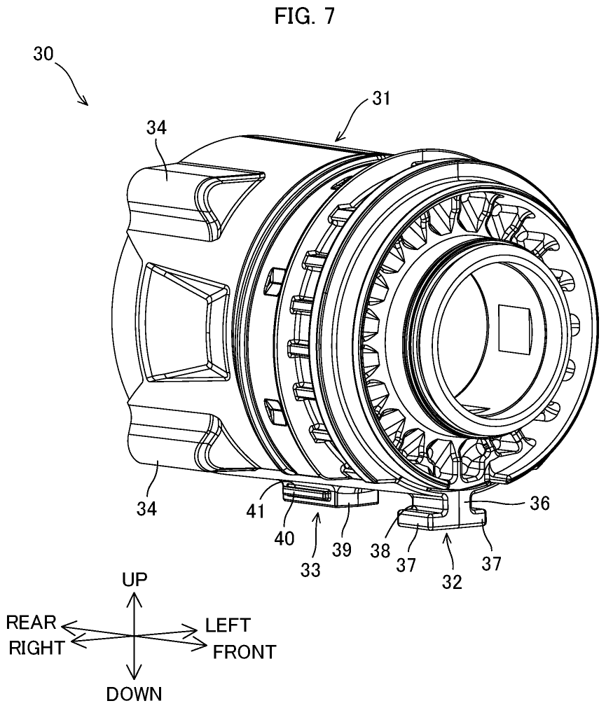

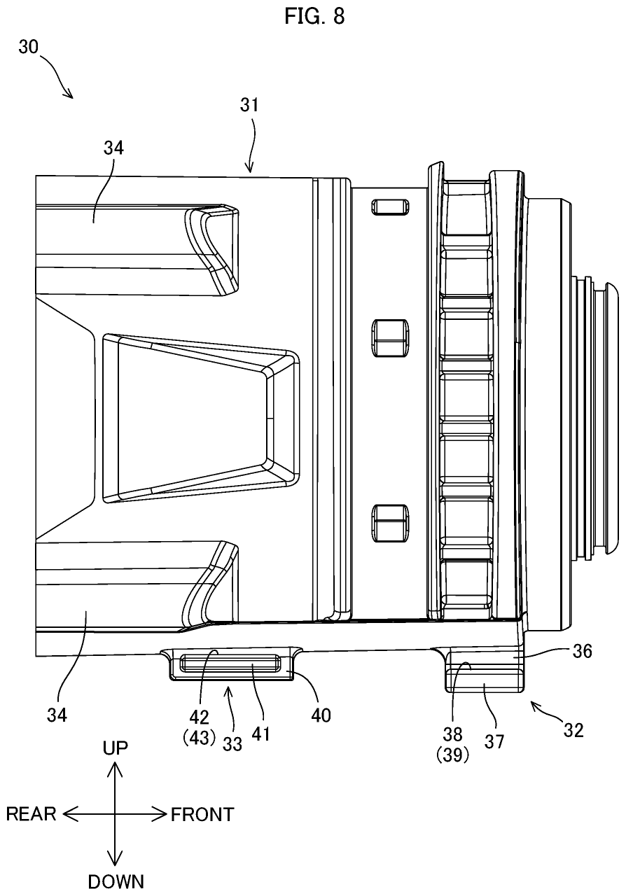

As illustrated in FIGS. 7 and 8, the hammer case 30 includes a tubular portion 31, a front protrusion portion 32, and a rear protrusion portion 33. The tubular portion 31 has a generally cylindrical shape extending in the front-rear direction. The spindle 25 and the impact mechanism 26 are contained in the tubular portion 31 as described above. As illustrated in FIGS. 1 to 4, 7, and 8, the tubular portion 31 includes four threaded bosses 34 on the rear edge portion thereof. The four threaded bosses 34 are distributed in the circumferential direction with respect to the rotational axis AX1. The tubular portion 31 is coupled with the motor containing portion 55 by threaded joining using the threaded bosses 34. More specifically, the motor containing portion 55 and the tubular portion 31 are integrated by being fastened together using four screws 35 respectively inserted in the four threaded bosses 34.

As illustrated in FIGS. 7 and 8, each of the front protrusion portion 32 and the rear protrusion portion 33 protrude from the tubular portion 31 radially outward on the front side with respect to a coupling position between the motor containing portion 55 and the tubular portion 31. The front protrusion portion 32 and the rear protrusion portion 33 are spaced apart in the front-rear direction. In the front-rear direction, the front protrusion portion 32 and the rear protrusion portion 33 are located at positions corresponding to a front half and a rear half of the hammer case 30, respectively. More specifically, the front protrusion portion 32 is located near the front edge portion of the tubular portion 31, and the rear protrusion portion 33 is located partially on the front side with respect to the threaded bosses 34.

As illustrated in FIGS. 7 and 8, the front protrusion portion 32 includes a front base portion 36 and a front rib 37. The front base portion 36 protrudes from the lowest portion of the tubular portion 31 downward. The front rib 37 extends from the front base portion 36 in a direction intersecting with the up-down direction. In the present embodiment, the front rib 37 extends from the front base portion 36 in a direction (the left-right direction) orthogonal to the up-down direction. Further, the front rib 37 includes a portion extending from the front base portion 36 rightward and a portion extending from the front base portion 36 leftward.

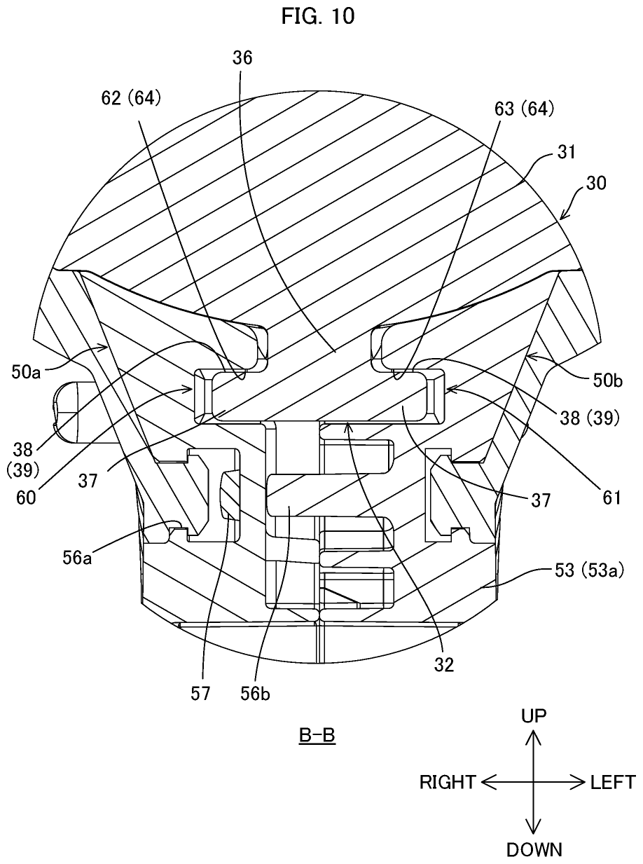

As illustrated in FIGS. 9 and 10, the upper end portion 53a of the support rod portion 53 includes recessed portions 60 and 61. More specifically, a portion of the right portion 50a that forms the upper end portion 53a includes the recessed portion 60, and a portion of the left portion 50b that forms the upper end portion 53a includes the recessed portion 61. Each of the recessed portions 60 and 61 is opened toward inside the upper end portion 53a in the left-right direction. The recessed portion 60 is sized and shaped in conformity with the right portion of the front rib 37 of the front protrusion portion 32, and the recessed portion 61 is sized and shaped in conformity with the left portion of the front rib 37. The front rib 37 is contained in the recessed portions 60 and 61.

In the present embodiment, the front rib 37 is contained in the recessed portions 60 and 61 in abutment with the upper inner surface and the lower inner surface defining the recessed portions 60 and 61. In other words, the front rib 37 is fitted in the recessed portions 60 and 61. Therefore, an upper surface 38 of the front rib 37 is constantly engaged (in abutment) with an upper inner surface 62 defining the recessed portion 60 and an upper inner surface 63 defining the recessed portion 61 in the up-down direction. The upper inner surfaces 62 and 63 are surfaces facing downward. Portions of the upper inner surfaces 62 and 63 that are engaged with the upper surface 38 of the front rib 37 will also be referred to as a front first engagement portion 64. A portion of the upper surface 38 of the front rib 37 that is engaged with the upper inner surfaces 62 and 63 will also be referred to as a front second engagement portion 39. The front second engagement portion 39 is located on the lower side with respect to the front first engagement portion 64. The front first engagement portion 64 and the front second engagement portion 39 are engaged in surface contact with each other.

As illustrated in FIGS. 9 and 10, the front protrusion portion 32 is located on the upper side with respect to the threaded bosses 56a and 56b located highest out of the threaded bosses 56a and 56b of the support rod portion 53. Therefore, any of the plurality of screws 57, which joins the right potion 50a and the left portion 50b together, does not penetrate through the front protrusion portion 32. The same also applies to the rear protrusion portion 33, which will be described below.

As illustrated in FIGS. 7 and 8, the rear protrusion portion 33 includes a rear base portion 40 and a rear rib 41. The rear base portion 40 protrudes from the lowest portion of the tubular portion 31 downward. The rear rib 41 extends from the rear base portion 40 in a direction intersecting with the up-down direction. In the present embodiment, the rear rib 41 extends from the rear base portion 40 in a direction (the left-right direction) orthogonal to the up-down direction. Further, the rear rib 41 includes a portion extending from the rear base portion 40 rightward and a portion extending from the rear base portion 40 leftward (only the portion extending from the rear base portion 40 rightward is visible in FIGS. 7 and 8).

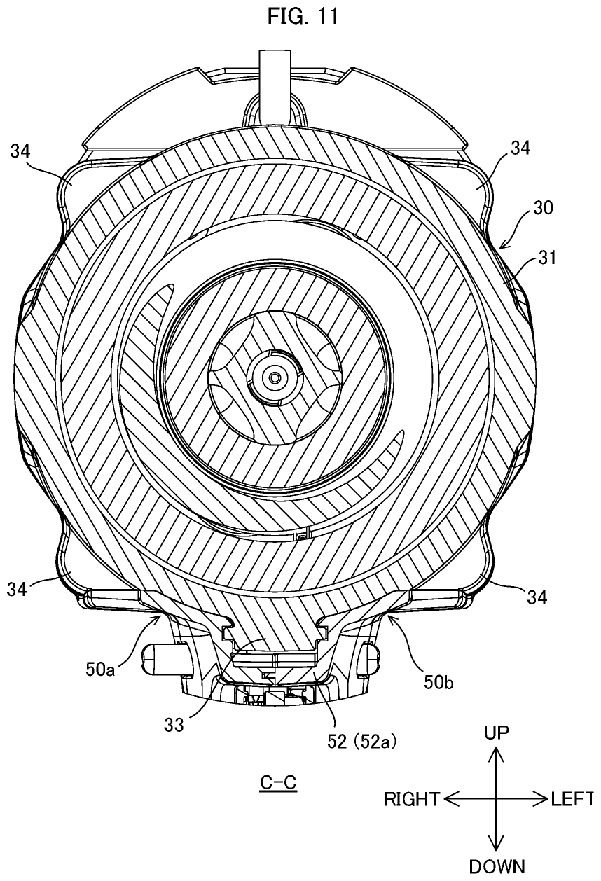

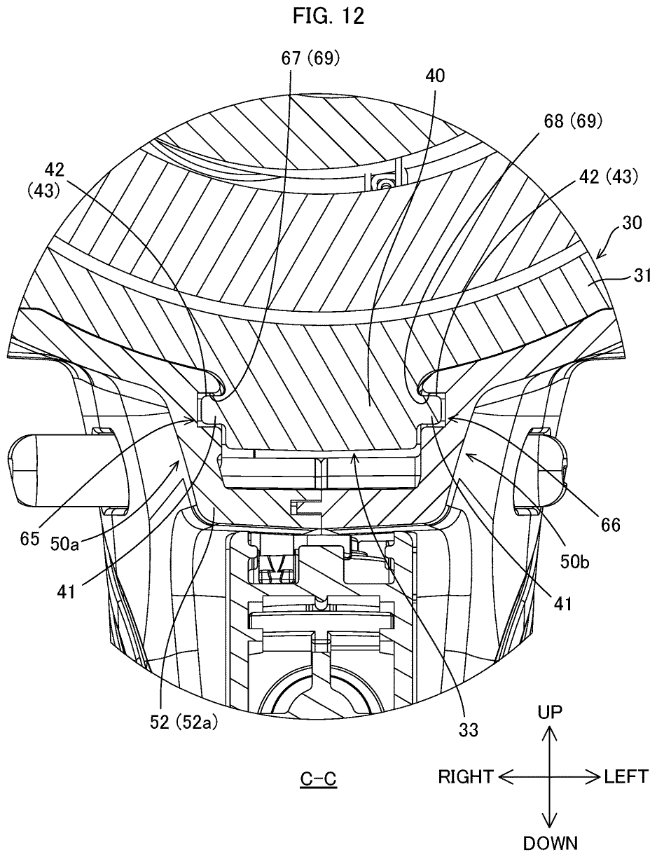

As illustrated in FIGS. 11 and 12, an upper end portion 52a of the handle portion 52 includes recessed portions 65 and 66. More specifically, a portion of the right portion 50a that forms the upper end portion 52a includes the recessed portion 65, and a portion of the left portion 50b that forms the upper end portion 52a includes the recessed portion 66. Each of the recessed portions 65 and 66 is opened toward inside the upper end portion 52a in the left-right direction. The recessed portion 65 is sized and shaped in conformity with the right portion of the rear rib 41 of the rear protrusion portion 33, and the recessed portion 66 is sized and shaped in conformity with the left portion of the rear rib 41. The rear rib 41 is contained in the recessed portions 65 and 66.

In the present embodiment, the rear rib 41 is contained in the recessed portions 65 and 66 in abutment with the upper inner surface and the lower inner surface defining the recessed portions 65 and 66. In other words, the rear rib 41 is fitted in the recessed portions 65 and 66. Therefore, an upper surface 42 of the rear rib 41 is constantly engaged (in abutment) with an upper inner surface 67 defining the recessed portion 65 and an upper inner surface 68 defining the recessed portion 66 in the up-down direction. The upper inner surfaces 67 and 68 are surfaces facing downward. Portions of the upper inner surfaces 67 and 68 that are engaged with the upper surface 42 of the rear rib 41 will also be referred to as a rear first engagement portion 69. A portion of the upper surface 42 of the rear rib 41 that is engaged with the upper inner surfaces 67 and 68 will also be referred to as a rear second engagement portion 43. The rear second engagement portion 43 is located on the lower side with respect to the rear first engagement portion 69. The rear first engagement portion 69 and the rear second engagement portion 43 are engaged in surface contact with each other.

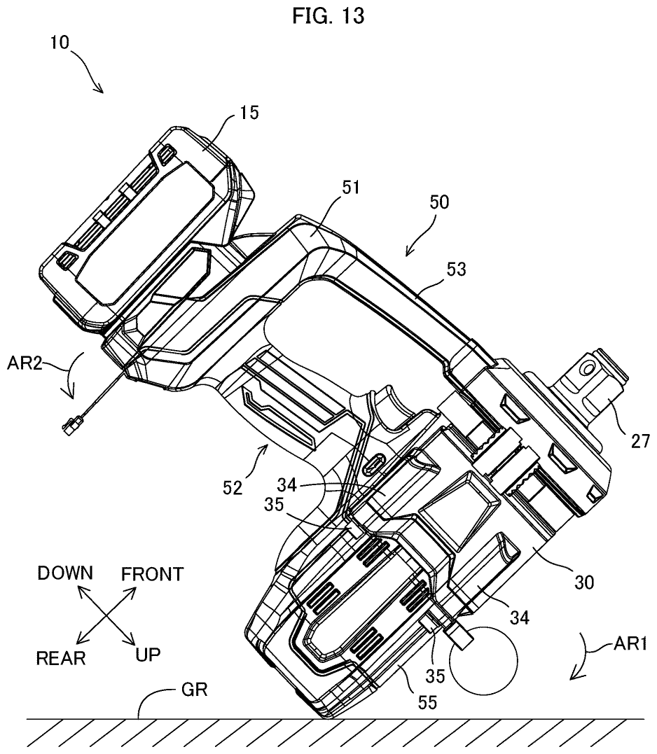

In the case of the above-described impact wrench 10, when the impact wrench 10 is dropped and lands the motor containing portion 55 first to cause the motor containing portion 55 to hit a ground GR, a moment in a direction indicated by an arrow AR1 is applied to the motor containing portion 55 containing the motor 21, which is a heavy component, as illustrated in FIG. 13. On the other hand, a moment in a direction indicated by an arrow AR2 opposite from the arrow AR1 is applied to the battery 15, which is a heavy component. Due to these moments in the opposite directions, a further strong force (a drop-time applied force) is applied to the coupling portion between the hammer case 30 and the motor containing portion 55 using the screws 35, and may cause damage on this coupling portion.

However, according to the impact wrench 10, such damage on the coupling portion can be reduced or prevented. More specifically, when the impact wrench 10 is subjected to the drop-time applied force, the upper end portion 53a of the support rod portion 53 is subjected to a downward force and the front protrusion portion 32 of the hammer case 30 is subjected to an upward force. The front first engagement portion 64 of the upper end portion 53a of the support rod portion 53 of the housing 50 and the front second engagement portion 39 of the front protrusion portion 32 of the hammer case 30 are engaged in the up-down direction, and the front second engagement portion 39 is located on the lower side with respect to the front first engagement portion 64. Therefore, the front first engagement portion 64 and the front second engagement portion 39 can withstand the drop-time applied force applied in the above-described direction. As a result, the damage on the coupling portion can be reduced or prevented.

Similarly, when the drop-time applied force is applied, the upper end portion 52a of the handle portion 52 is subjected to a downward force and the rear protrusion portion 33 of the hammer case 30 is subjected to an upward force. Therefore, the rear first engagement portion 69 and the rear second engagement portion 43 can withstand the drop-time applied force applied in the above-described direction. According to this configuration, the drop-time applied force can be received at two portions spaced apart in the front-rear direction (the engagement portion between the front first engagement portion 64 and the front second engagement portion 39, and the engagement portion between the rear first engagement portion 69 and the rear second engagement portion 43). In other words, the impact wrench 10 receives the drop-time applied force at a larger number of portions. Therefore, the present configuration makes the joint portion even less prone to damage.

Further, according to the front protrusion portion 32, the front base portion 36 protrudes from the lowest portion of the tubular portion 31 downward, and the front rib 37 including the front second engagement portion 39 extends from the front base portion 36 in the direction intersecting with the up-down direction. Therefore, the size of the impact wrench 10 can be reduced in the left-right direction. Further, a similar advantageous effect can also be acquired due to the rear protrusion portion 33.

Further, according to the front protrusion portion 32, the front rib 37 including the front second engagement portion 39 extends in the direction orthogonal to the up-down direction. Further, the upper surface 38 of the front rib 37 functions as the front second engagement portion 39. Therefore, the present configuration facilitates positioning of the hammer case 30 and the housing 50, thus facilitating manufacturing of the impact wrench 10. Further, a similar advantageous effect can also be acquired due to the rear protrusion portion 33.

Further, according to the front protrusion portion 32, the front rig 37 extends from the front base portion 36 rightward and leftward. Due to that, the front first engagement portion 64 and the front second engagement portion 39 can receive the drop-time applied force in a well-balanced manner between the left side and the right side. Therefore, the present configuration makes the joint portion even less prone to damage. Further, a similar advantageous effect can also be acquired due to the rear protrusion portion 33.

Further, according to the impact wrench 10, the upper end portion 53a of the support rod portion 53 includes the recessed portions 60 and 61 in which the front rib 37 of the front protrusion portion 32 is contained, and the upper inner surfaces 62 and 63 defining the recessed portions 60 and 61 function as the front first engagement portion 64. Therefore, the hammer case 30 and the housing 50 can be easily positioned. Further, this configuration can eliminate or reduce the occurrence of rattling between the hammer case 30 and the housing 50. Further, a similar advantageous effect can also be acquired due to the recessed portions 65 and 66 of the handle portion 52.

Further, according to the impact wrench 10, the front first engagement portion 64 and the front second engagement portion 39 are engaged in surface contact with each other. Therefore, the front first engagement portion 64 and the front second engagement portion 39 can stably receive the drop-time applied force over a wider area compared with point contact or linear contact.

Further, according to the impact wrench 10, the front protrusion portion 32 is located at a position corresponding to the front half of the hammer case 30 in the front-rear direction. Therefore, the engagement portion between the front first engagement portion 64 and the front second engagement portion 39 can be located away from the joint portion using the screws 35, and this leads to an increase in a moment in a direction for receiving the drop-time applied force. Therefore, the present configuration can reduce a load that should be received by the front first engagement portion 64 and the front second engagement portion 39 at the time of a drop. In addition, the front first engagement portion 64 is provided on the upper end portion 53a of the support rod portion 53 located on the front side with respect to the handle portion 52, and therefore the engagement portion between the front first engagement portion 64 and the front second engagement portion 39 can be shifted further forward. Due to that, the present configuration can further reduce a load that should be received by the front first engagement portion 64 and the front second engagement portion 39 at the time of a drop.

Further, according to the impact wrench 10, any of the plurality of screws 57, which joins the right portion 50a and the left portion 50b of the housing 50 together, does not penetrate through the front protrusion portion 32 and the rear protrusion portion 33. Therefore, the present configuration eliminates the necessity of designing some of the plurality of screws 57 according to specifications capable of withstanding the drop-time applied force. In other words, the plurality of screws 57 can be designed according to common specifications, and the impact wrench 10 can be manufactured with less time and labor.

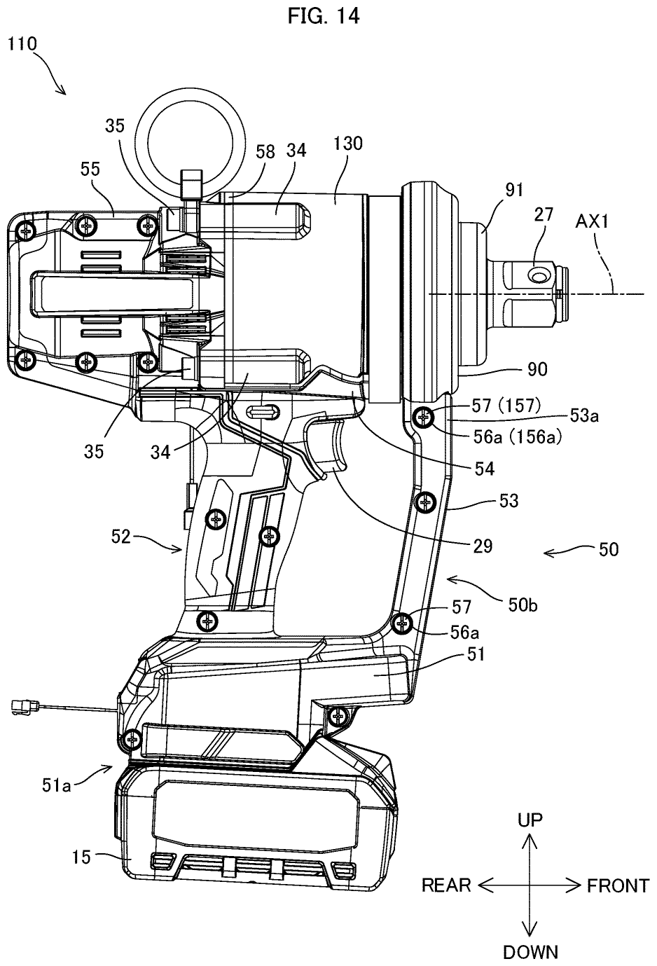

In the following description, an impact wrench 110 according to a second embodiment will be described with reference to FIGS. 14 to 17, focusing only on differences from the first embodiment. In FIGS. 14 to 17, components similar to the first embodiment are identified by the same reference numerals as the first embodiment. As illustrated in FIG. 14, the impact wrench 110 is different from the first embodiment in terms of the shape of a first bumper 90, and, as a result, the threaded boss 56a and the screw 57 located at the upper end portion 53a of the support rod portion 53 are exposed outward. In the drawings, these treaded boss 56a and screw 57 located at the upper end portion 53a are indicated as a threaded boss 156a and a screw 157, respectively.

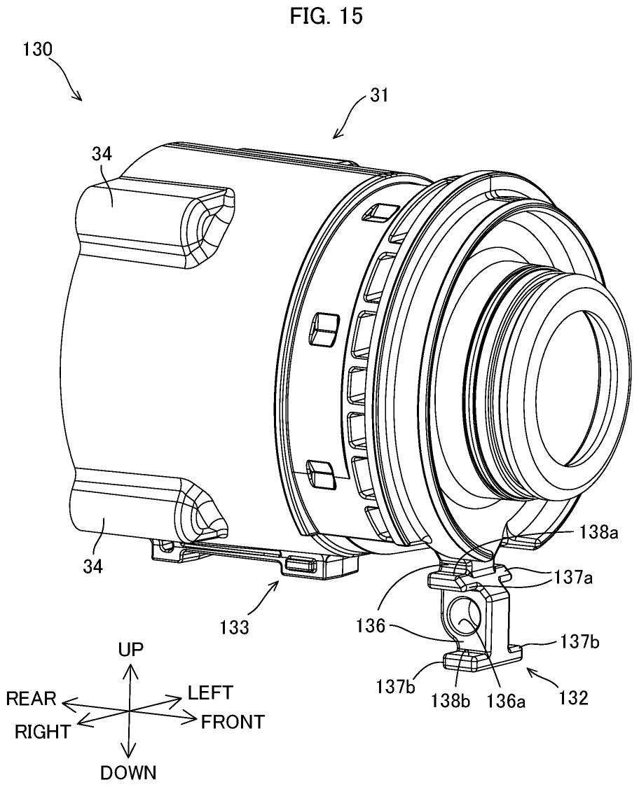

The impact wrench 110 includes a hammer case 130 instead of the hammer case 30 according to the first embodiment. As illustrated in FIG. 15, the hammer case 130 includes a front protrusion portion 132 and a rear protrusion portion 133. The rear protrusion portion 133 functions similarly to the rear protrusion portion 33 although being located and sized slightly differently from the rear protrusion portion 33 according to the first embodiment. Therefore, a description of the rear protrusion portion 133 will be omitted here.

As illustrated in FIG. 15, the front protrusion portion 132 includes a front base portion 136, an upper rib 137a, and a lower rib 137b. The front base portion 136 protrudes from the lowest portion of the tubular portion 31 downward. The upper rib 137a extends from the front base portion 136 in a direction intersecting with the up-down direction between the upper end and the lower end of the front base portion 136. In the present embodiment, the upper rib 137a extends from the front base portion 136 in a direction (the left-right direction) orthogonal to the up-down direction. Further, the upper rib 137a includes a portion extending from the front base portion 136 rightward and a portion extending from the front base portion 136 leftward. The lower rib 137b extends from the front base portion 136 in a direction intersecting with the up-down direction at the lower end of the front base portion 136. In the present embodiment, the lower rib 137b extends from the front base portion 136 in a direction (the left-right direction) orthogonal to the up-down direction. Further, the lower rib 137b includes a portion extending from the front base portion 136 rightward and a portion extending from the front base portion 136 leftward. The front base portion 136 includes a through-hole 136a between the upper rib 137a and the lower rib 137b in the up-down direction. The through-hole 136a extends through the front base portion 136 in the left-right direction.

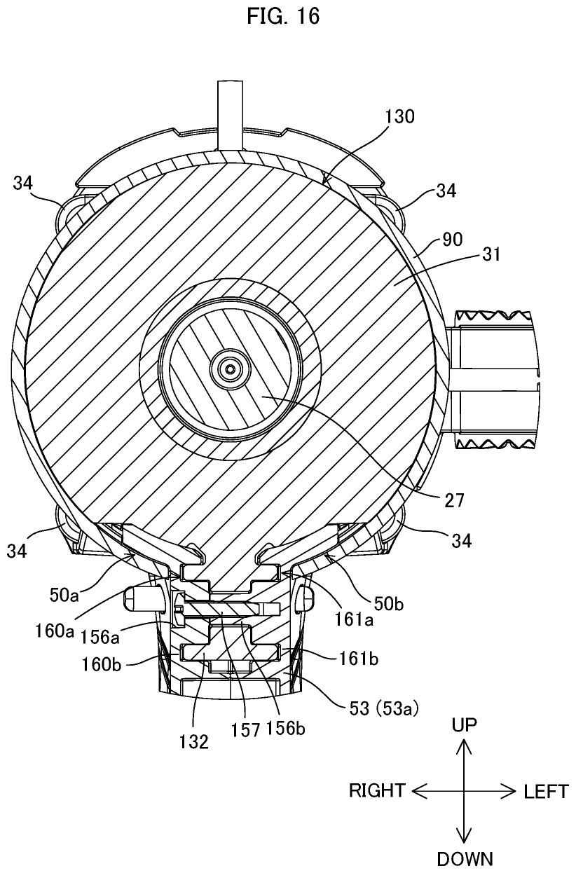

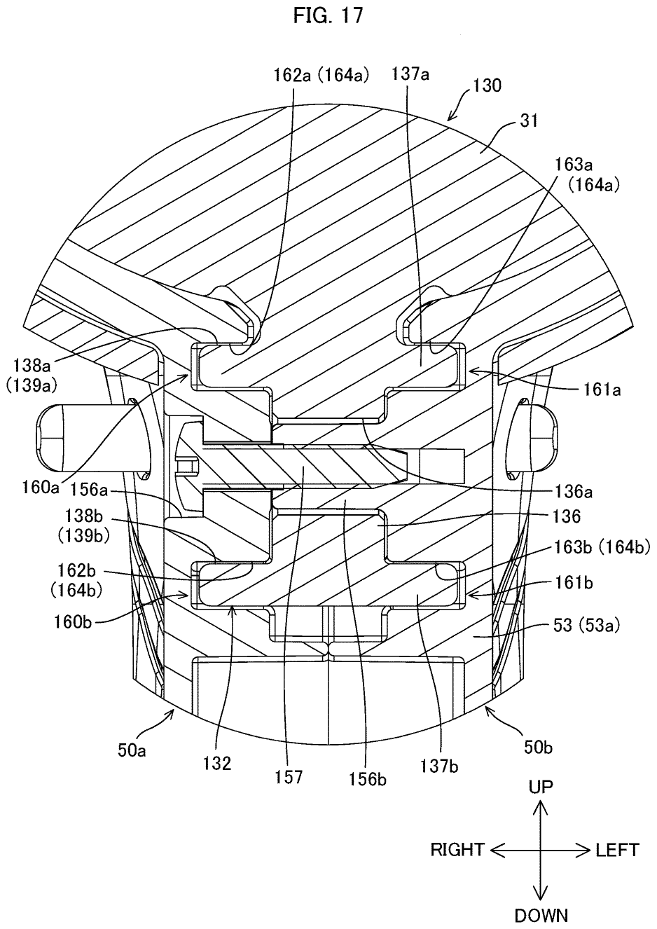

As illustrated in FIGS. 16 and 17, the upper end portion 53a of the support rod portion 53 includes recessed portions 160a, 160b, 161a, and 161b. More specifically, the portion of the right portion 50a that forms the upper end portion 53a includes the recessed portions 160a and 160b, and the portion of the left portion 50b that forms the upper end portion 53a includes the recessed portions 161a and 161b. Each of the recessed portions 160a, 160b, 161a, and 161b is opened toward inside the upper end portion 53a in the left-right direction. The recessed portion 160a is located on the upper side with respect to the recessed portion 160b, and the recessed portion 161a is located on the upper side with respect to the recessed portion 161b. The recessed portions 160a and 160b are respectively sized and shaped in conformity with the right portions of the upper rib 137a and the lower rib 137b of the front protrusion portion 132, and the recessed portions 161a and 161b are respectively sized and shaped in conformity with the left portions of the upper rib 137a and the lower rib 137b. The upper rib 137a is contained in the recessed portions 160a and 161a, and the lower rib 137b is contained in the recessed portions 160b and 161b.

Similarly to the first embodiment, an upper surface 138a of the upper rib 137a is engaged with an upper inner surface 162a defining the recessed portion 160a and an upper inner surface 163a defining the recessed portion 161a in the up-down direction. Similarly, an upper surface 138b of the lower rib 137b is engaged with an upper inner surface 162b defining the recessed portion 160b and an upper inner surface 163b defining the recessed portion 161b in the up-down direction. Portions of the upper inner surfaces 162a and 163a that are engaged with the upper surface 138a of the upper rib 137a will also be referred to as an upper first engagement portion 164a. A portion of the upper surface 138a that is engaged with the upper inner surfaces 162a and 163a will also be referred to as an upper second engagement portion 139a. Similarly, portions of the upper inner surfaces 162b and 163b that are engaged with the upper surface 138b of the lower rib 137b will also be referred to as a lower first engagement portion 164b. A portion of the upper surface 138b that is engaged with the upper inner surfaces 162b and 163b will also be referred to as a lower second engagement portion 139b.

As illustrated in FIGS. 16 and 17, the right end of the threaded boss 156b of the left portion 50b corresponding to the threaded boss 156a of the right portion 50a is inserted in the through-hole 136a of the front protrusion portion 132. Therefore, the screw 157 joining the right portion 50a and the left portion 50b together penetrates through the front protrusion portion 132 in the left-right direction by extending through the through-hole 136a.

According to the above-described impact wrench 110, the drop-time applied force can be received at two portions spaced apart in the up-down direction (the engagement portion between the upper first engagement portion 164a and the upper second engagement portion 139a, and the engagement portion between the lower first engagement portion 164b and the lower second engagement portion 139b). In other words, the impact wrench 110 receives the drop-time applied force at a larger number of portions. Therefore, the present configuration makes the threaded joint portion between the hammer case 130 and the motor containing portion 55 even less prone to damage.

Further, according to the impact wrench 110, the screw 157 located at the upper end portion 53a of the support rod portion 53 joins the right portion 50a and the left portion 50b together in a state of penetrating through the front protrusion portion 132. According to this configuration, the screw 157 and the threaded boss 156b extending through the front protrusion portion 132 can also receive the drop-time applied force additionally between them and the inner surface of the front protrusion portion 132 defining the through-hole 136a. Therefore, the present configuration makes the threaded joint portion between the hammer case 130 and the motor containing portion 55 even less prone to damage.

The above-described first embodiment and second embodiment are intended to only facilitate the understanding of the present teaching, and are not intended to limit the present invention thereto. The present invention can be modified or improved without departing from the spirit thereof, and the present invention includes equivalents thereof. Further, each of the elements described in the claims and the specification can be combined in any manner or omitted in any manner within a range that allows it to remain capable of achieving at least a part of the above-described objects or bringing about at least a part of the above-described advantageous effects.

For example, the positions and the shapes of the protrusion portions 32 and 33 can be changed in any manner as long as the second engagement portion of the hammer case 30 is located on the lower side with respect to the first engagement portion of the housing 50 and the first engagement portion and the second engagement portion can withstand the drop-time applied force. The same also applies to the front protrusion portions 132 and 133. Further, the position and the shape of the housing 50 (the first engagement portion) can also be changed in any manner according to the positions and the shapes of the protrusion portions 32 and 33. For example, the protrusion portion 32 may protrude from the tubular portion 31 in a direction angled with respect to the up-down direction. Alternatively, the front rib 37 may extend from the front base portion 36 in a direction non-orthogonally intersecting with the up-down direction. Alternatively, the front rib 37 may extend in the front-rear direction instead of or in addition to the left-right direction, and, for example, may extend from the front base portion 36 in a flange-like manner.

Further, the hammer case 30 may include only one of the protrusion portions 32 and 33, and the hammer case 130 may include only one of the front protrusion portions 132 and 133. Further, the front protrusion portion 132 may include only one of the upper rib 137a and the lower rib 137b. Alternatively, the front protrusion portion 132 may be modified so as not to include the through-hole 136a between the upper rib 137a and the lower rib 137b. In this case, the screw 157 joins the right portion 50a and the left portion 50b together on the lower side with respect to the front protrusion portion 132.

Further, the front rib 37 of the front protrusion portion 32 may be contained in the recessed portion 60 and the recessed portion 61 with a slight clearance generated in the up-down direction. Such a configuration can also reduce or prevent damage on the threaded joint portion between the hammer case 130 and the motor containing portion 55 similarly to the above-described embodiment, as the front first engagement portion 64 and the front second engagement portion 39 are engaged after the housing 50 is deflected by an amount corresponding to the clearance. The same also applies to the protrusion portions 33, 132, and 133.

The above-described various embodiments are applicable to not only the impact wrench but also various electric tools (for example, an impact driver) including a metallic casing.

The corresponding relationship between each component in the above-described embodiments and each component recited in the claims will be described now. However, each component in the embodiments is merely one example and shall not limit each component of the present invention. The impact wrench 10 is one example of an “electric tool”. The anvil 27 is one example of a “final output shaft”. The hammer case 30 is one example of a “metallic casing”. The support rod portion 53 is one example of a “resin housing”. The front rib 37, the rear rib 41, the upper rib 137a, and the lower rib 137b are one example of an “intersection-direction extending portion”.

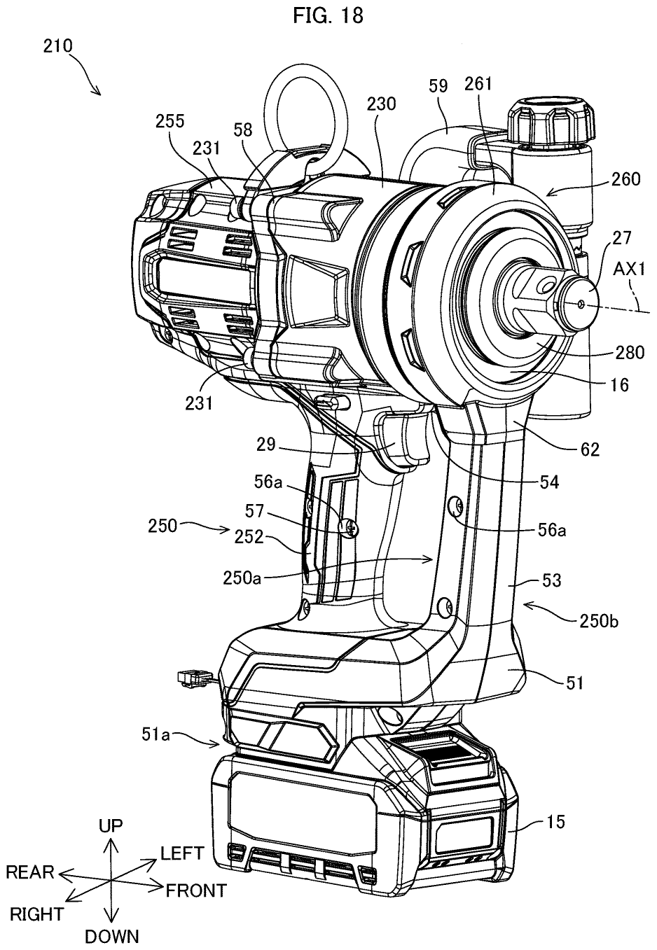

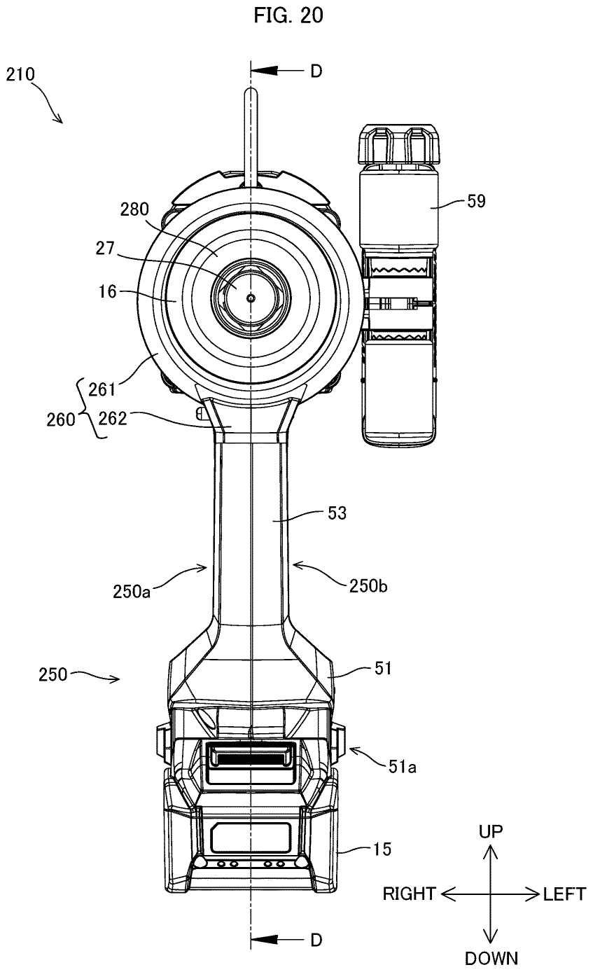

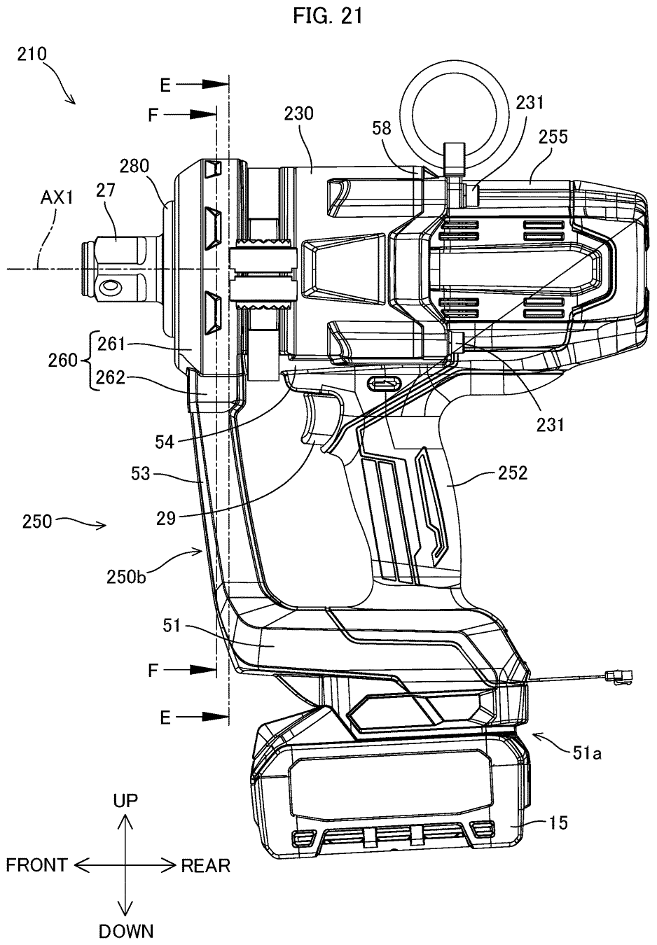

In the following description, an impact wrench 210 according to a representative and non-limiting third embodiment of the present disclosure will be described more specifically with reference to FIGS. 18 to 30. In the following description (including the drawings), components indicated by the same reference numerals as the reference numerals assigned to the components in the first embodiment or the second embodiment are configured similarly to the corresponding components in the first embodiment or the second embodiment, and descriptions thereof may be omitted. As illustrated in FIGS. 18 to 22, the impact wrench 210 includes a metallic hammer case 230 and a resin housing 250. The housing 250 includes the battery holding portion 51, a handle 252, the support rod portion 53, the coupling portion 54, and a motor housing 255.

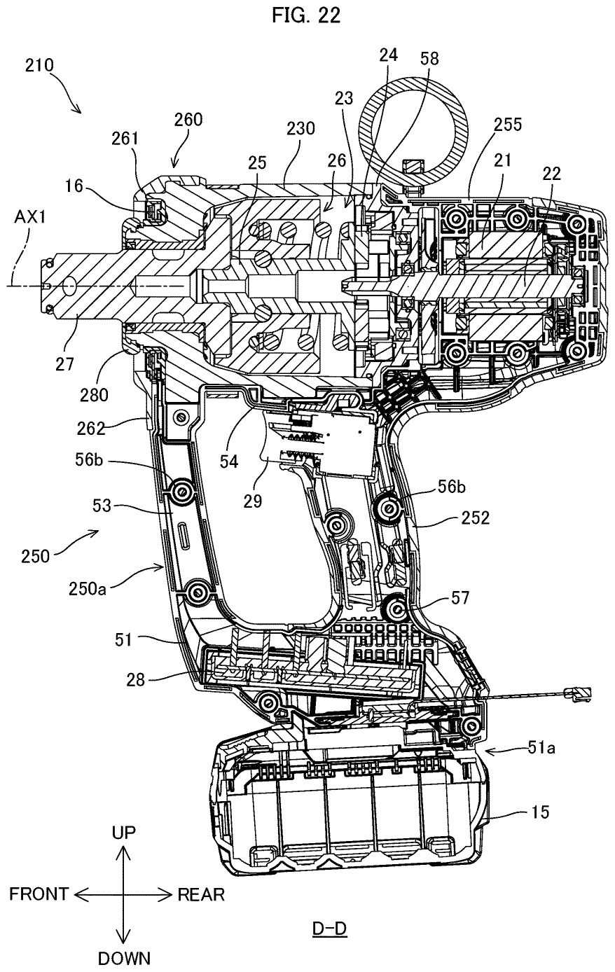

As illustrated in FIG. 22, the motor housing 255 is tubularly shaped, and the motor 21 including the motor shaft 22 is contained in the motor housing 255.

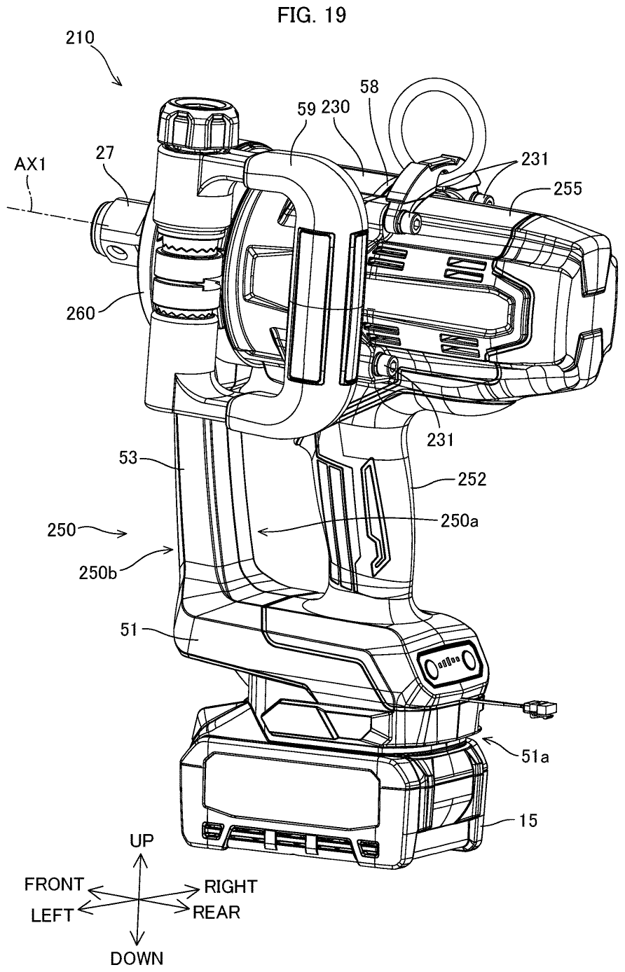

As illustrated in FIG. 22, the gear case 58 holding the speed reduction mechanism 24 is disposed adjacent to the motor housing 255. The hammer case 230 is disposed adjacent to the gear case 58. The hammer case 230 is configured similarly to the hammer case 30 according to the first embodiment. The motor housing 255, the gear case 58, and the hammer case 230 are integrated by being fastened together using four screws 231 extending in parallel with the rotational axis AX1. As illustrated in FIGS. 18 and 19, the four screws 231 are distributed in the circumferential direction with respect to the rotational axis AX1.

The handle 252 is configured similarly to the handle portion 52 according to the first embodiment. As illustrated in FIGS. 18 to 22, the handle 252 extends elongatedly in a direction intersecting with (more specifically, generally orthogonal to) the rotational axis AX1. The handle 252 is a portion held by a user when the impact wrench 210 is in use. The handle 252 is located between the hammer case 230 and the battery holding portion 51 in the direction orthogonal to the rotational axis AX1.

As illustrated in FIGS. 18 to 21, the housing 250 has a half-divided structure dividable into a first portion 250a and a second portion 250b in the present embodiment. The first portion 250a and the second portion 250b are configured similarly to the right portion 50a and the left portion 50b according to the first embodiment, respectively.

As illustrated in FIGS. 18 to 22, a first bumper 260 and a second bumper 280 as protective covers are attached to the hammer case 230. The first bumper 260 and the second bumper 280 are made of elastic materials. In the present embodiment, the first bumper 260 and the second bumper 280 are made of rubber. As will be described in detail below, the first bumper 260 is detachably attached to the hammer case 230 and the support rod portion 53 from the front side. The first bumper 260 covers a portion of the hammer case 230 that is located on the front side around the rotational axis AX1 in its attached state.

The second bumper 280 covers the front edge portion of the hammer case 230 around the rotational axis AX1. The second bumper 280 includes an annular protrusion portion 281 that protrudes radially inward. The hammer case 230 includes an annular recessed portion 232 at the distal end portion thereof. The second bumper 280 is detachably attached to the front edge portion of the hammer case 230 by inserting the annular protrusion portion 281 into the annular recessed portion 282.

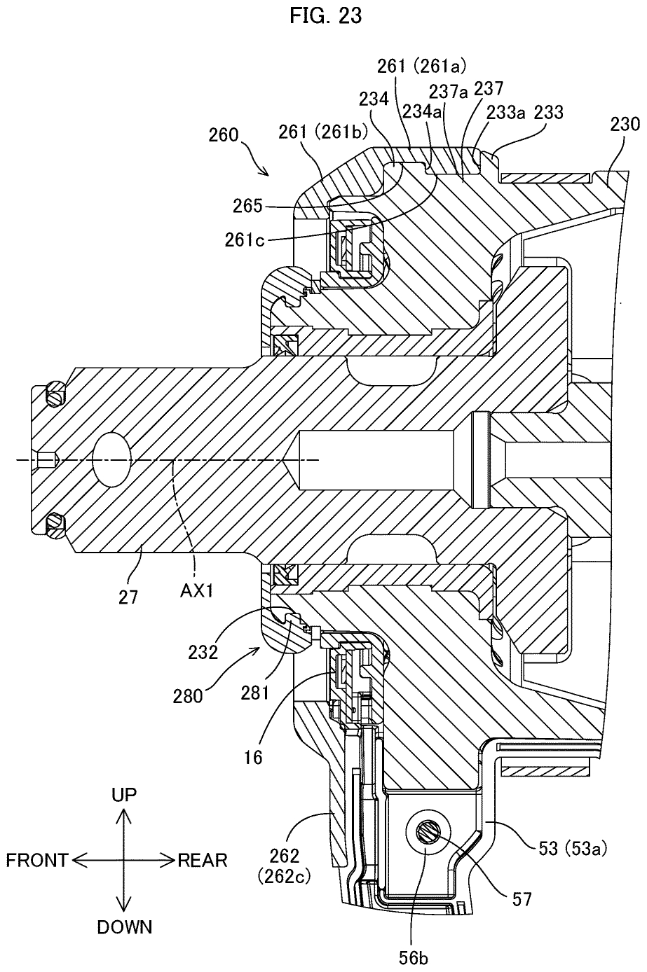

As illustrated in FIG. 23, the first bumper 260 and the second bumper 280 each cover the front end surface of the hammer case 230 radially inside and outside the illumination unit 16. Therefore, the first bumper 260 and the second bumper 280 prevent the front end surface of the hammer case 230 from colliding with an external object (for example, a wheel when a tire is replaced using the impact wrench 210) to inflict damage on this object when the impact wrench 210 is in use. The first bumper 260 and the second bumper 280 also have a function of protecting the illumination unit 16 from collision.

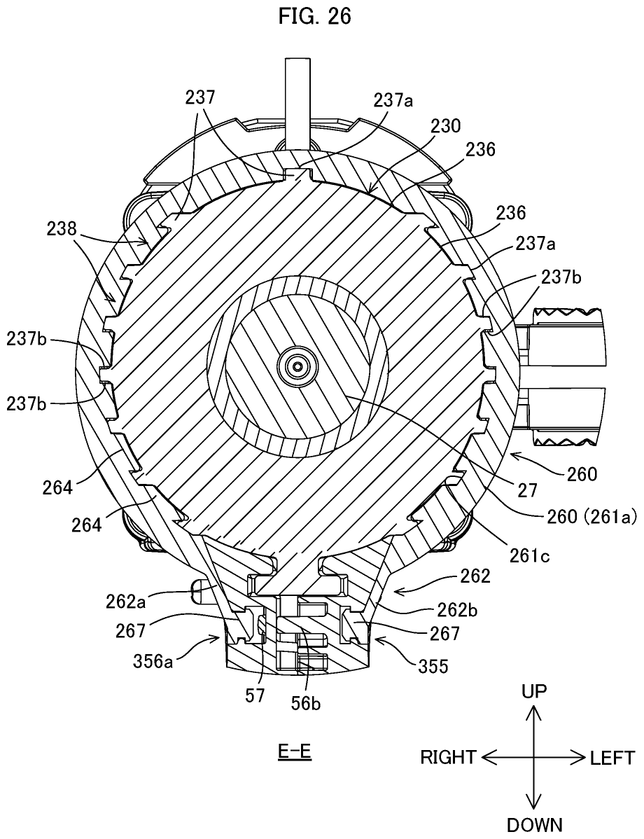

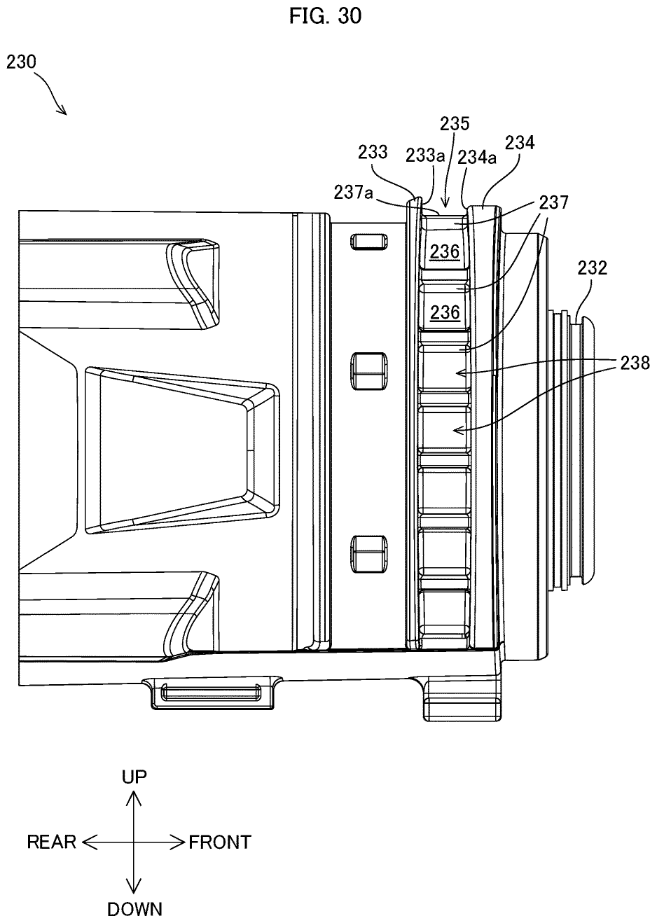

In the following description, a configuration for attaching the first bumper 260 to the hammer case 230 will be described in detail. As illustrated in FIG. 30, the hammer case 230 includes a first outer-diameter portion 233, a second outer-diameter portion 234, and an annular groove portion 235. The second outer-diameter portion 234 is located on the front side with respect to the first outer-diameter portion 233, and has a smaller outer diameter than the outer diameter of the first outer-diameter portion 233. The annular groove portion 235 is located between the first outer-diameter portion 233 and the second outer-diameter portion 234. The annular groove portion 235 includes a bottom portion 236 and a plurality of first protrusion portions 237. As illustrated in FIG. 26, the bottom portion 236 has a constant outer diameter. In other words, the radial position of the bottom portion 236 is the same at any circumferential position.

As illustrated in FIGS. 26 and 30, the plurality of first protrusion portions 237 are portions protruding from the bottom portion 236 radially outward. The plurality of first protruding portions 237 extend from the first outer-diameter portion 233 to the second outer-diameter portion 234 in the front-rear direction. The plurality of first protrusion portions 237 are arranged at intervals along the circumferential direction. A top portion 237a of the first protrusion portion 237 is located on the radially inner side with respect to the outer circumferential portion of the second outer-diameter portion 234. A plurality of recessed portions 238 are defined between the plurality of first protrusion portions 237. As illustrated in FIG. 26, the respective radial positions (i.e., outer diameters) of the plurality of top portions 237a are equal to one another.

As illustrated in FIG. 26, side surfaces 237b (circumferential side surfaces) of the plurality of first protrusion portions 237 are angled with respect to the radial direction. Further, the respective side surfaces 237b of the plurality of first protrusion portions 237 are inclined with respect to the radial direction at angles different from one another. More specifically, the first protrusion portion 237 located highest is generally rectangularly shaped as viewed in cross section orthogonal to the front-rear direction. The first protrusion portion 237 located in a region spanning downward from the first protrusion portion 237 located highest to a rotational angle position of 90 degrees includes an acute-angled corner portion located on the circumferentially lower side and an obtuse-angled corner portion located on the circumferentially upper side. The angle of the acute-angled corner portion increases (becomes blunter) as the position of the first protrusion portion 237 is lowered. The first protrusion portion 237 located at a position lowered downward from the first protrusion portion 237 located highest to the rotational angle position of 90 degrees is generally rectangularly shaped. The first protrusion portion 237 located in a region lowered downward from the first protrusion portion 237 located highest to a rotational angle position larger than 90 degrees includes an obtuse-angled corner portion located on the circumferentially lower side and an acute-angled corner portion located on the circumferential upper side. The angle of the acute-angled corner portion reduces (becomes sharper) as the position of the first protrusion portion 237 is lowered.

As illustrated in FIG. 26, the respective circumferential widths of the plurality of recessed portions 238 are different from one another. More specifically, the circumferential width of the recessed portion 238 located highest is the widest, and the circumferential width of the recessed portion 238 gradually reduces as the position of the recessed portion 238 is lowered from the highest position in the upper half region. Then, the circumferential width of the recessed portion 238 gradually increases as the position of the recessed portion 238 is lowered in the lower half region.

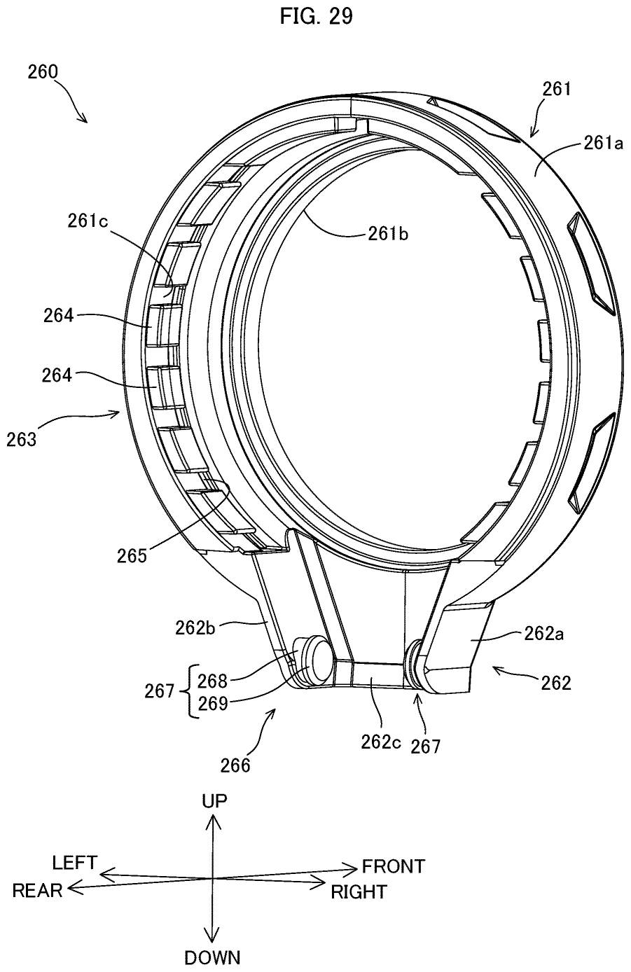

As illustrated in FIGS. 18, 23, 28, and 29, the first bumper 260 includes an annular portion 261 and a protrusion portion 262. The annular portion 261 is a portion that covers the hammer case 230 around the rotational axis AX1, and is generally cylindrically shaped. The annular portion 261 includes a rear portion 261a having a constant outer diameter, and a front portion 261b having a tapered shape gradually reducing toward the front side in diameter. As clearly seen from FIG. 29, the rear portion 261a has a generally C-like shape opened on the lower side as viewed in the front-rear direction. The protrusion portion 262 protrudes from the lower edge portion of the annular portion 261 radially outward. The protrusion portion 262 includes a right wall portion 262a, a left wall portion 262b, and a front wall portion 262c, and is opened on the lower side and the rear side thereof. The protrusion portion 262 is sized and shaped in conformity with the upper end portion of the support rod portion 53.

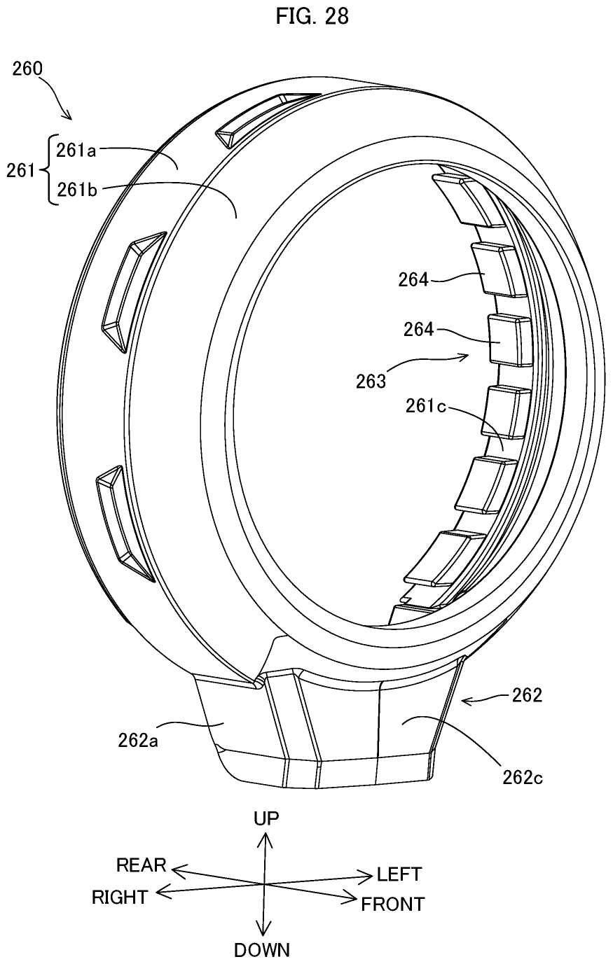

As illustrated in FIGS. 28 and 29, the annular portion 261 includes a first engagement portion 263. The first engagement portion 263 is detachably engaged with the hammer case 230 using the elasticity thereof. In the present embodiment, the first engagement portion 263 is in the form of a plurality of second protrusion portions 264. The plurality of second protrusion portions 264 protrude from an inner circumferential surface 261c of the rear portion 261a of the annular portion 261 radially inward. The plurality of second protrusion portions 264 are arranged at intervals in the circumferential direction.

The plurality of second protrusion portions 264 are sized and shaped approximately identically to the plurality of recessed portions 238 of the hammer case 230, and can be respectively inserted into the plurality of recessed portions 238 in conformity therewith due to elastic deformation as illustrated in FIG. 26. The respective circumferential widths of the plurality of recessed portions 238 are different from one another as described above, and therefore the respective circumferential widths of the plurality of second protrusion portions 264 are also different from one another. The rotational angle position of the first bumper 260 relative to the hammer case 230 around the rotational axis AX1 for allowing the plurality of second recessed portions 264 to be respectively inserted in the plurality of recessed portions 238 is uniquely determined. Therefore, more precisely, the plurality of second protrusion portions 264 are sized and shaped approximately identically to the plurality of recessed portions 238 located at the corresponding rotational angle position.

When the first bumper 260 is attached to the hammer case 230, the first bumper 260 is positioned in such a manner that the rear edge portion of the annular portion 261 is placed in abutment with a front side surface 233a of the first outer-diameter portion 233 as illustrated in FIG. 23. Further, the plurality of second protrusion portions 264 are pushed into the plurality of recessed portions 238, respectively, as illustrated in FIG. 26. At this time, the plurality of second protrusion portions 264 are engaged with the inner surfaces defining the plurality of recessed portions 238 so as to be prevented from slipping off from the plurality of recessed portions 238. More specifically, the plurality of second protrusion portions 264 are contained in the plurality of recessed portions 238 in an elastically deformed state, respectively. The second protrusion portions 264 contained in the recessed portions 238 are engaged with the inner surfaces defining the recessed portions 238 due to their restoring forces. The plurality of second protrusion portions 264 may be contained in the plurality of recessed portions 238 in a slightly compressed state and be securely engaged with the inner surfaces defining the plurality of recessed portions 238 due to their restoring forces.

The inner circumferential surface 261c of the annular portion 261 includes an annular groove 265 adjacent to the plurality of second protrusion portions 264 in front of the plurality of second protrusion portions 264. As illustrated in FIG. 23, the annular groove 265 is sized and shaped in conformity with the second outer-diameter portion 234 of the hammer case 230. The second outer-diameter portion 234 of the hammer case 230 is engaged with the annular groove 265 with the first bumper 260 attached.

As illustrated in FIG. 29, the protrusion portion 262 includes a second engagement portion 266. The second engagement portion 266 is detachably engaged with the housing 250 (more specifically, the upper end portion 53a of the support rod portion 53) using its elasticity. In the present embodiment, the second engagement portion 266 is in the form of a pair of protrusions 267 opposing in the left-right direction. One of the protrusions 267 protrudes from the inner surface of the left wall portion 262b rightward, and the other of the protrusions 267 protrudes from the inner surface of the right wall portions 262a leftward.

As illustrated in FIG. 29, the protrusions 267 each include a shaft portion 268 and a head portion 269. The shaft portion 268 is a columnar portion extending from the left wall portion 262b or the right wall portion 262a in the left-right direction. The head portion 269 is located at the distal end of the shaft portion 268, and has an outer diameter larger than the shaft portion 268.

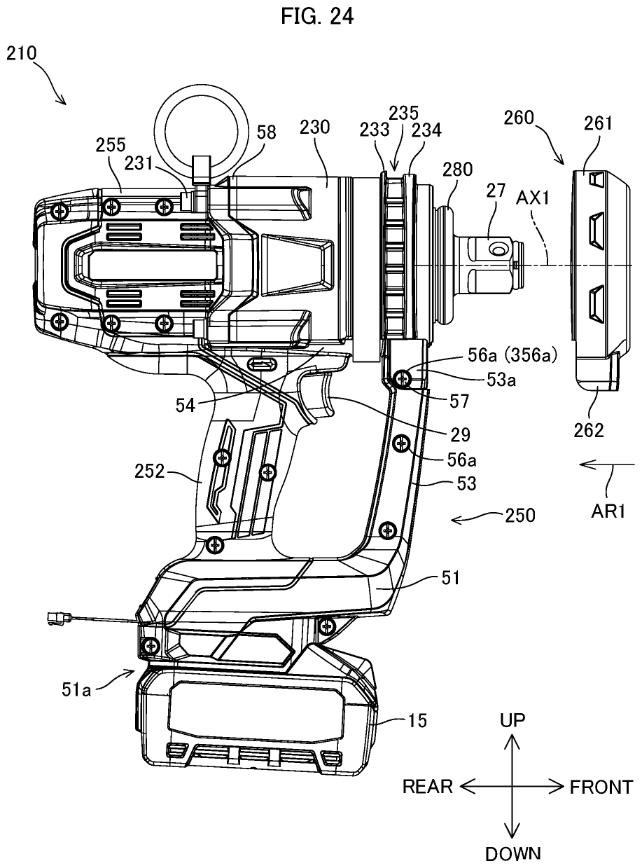

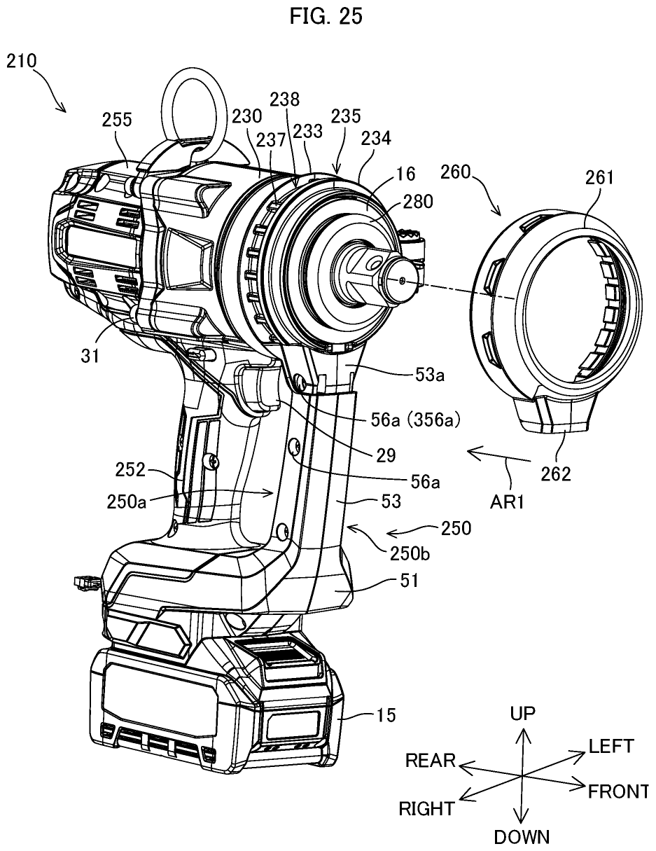

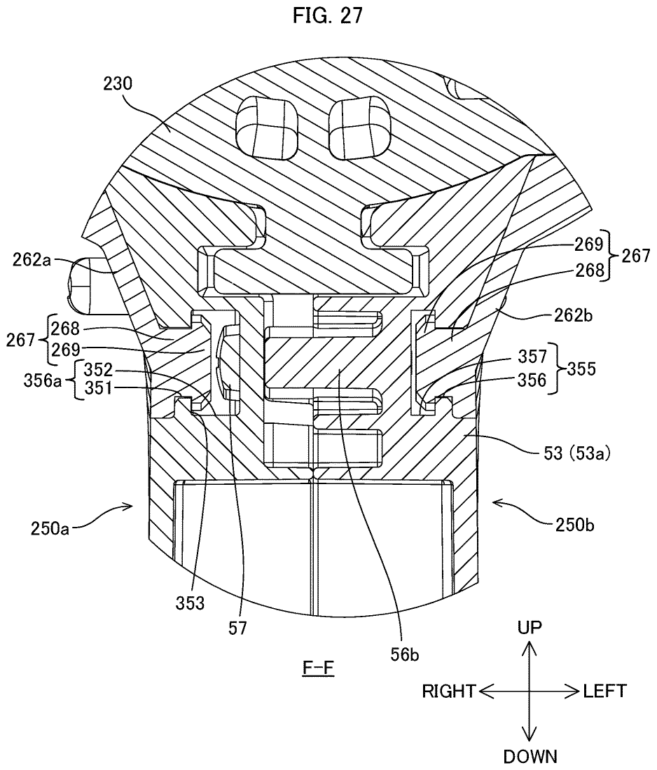

As illustrated in FIGS. 24 and 25, a portion of the upper end portion 53a of the support rod portion 53 that corresponds to the first portion 250a includes the threaded boss 56a. The threaded boss 56a is indicated as a threaded boss 356a in the drawings. As illustrated in FIG. 27, the threaded boss 356a includes a small-diameter hole portion 351 and a large-diameter hole portion 352. The small-diameter hole portion 351 is an outer (right) portion of the threaded boss 356a. The large-diameter hole portion 352 is continuous to the small-diameter hole portion 351 on the inner side (the left side) of the upper end portion 53a. The large-diameter hole portion 352 has an inner diameter larger than the small-diameter hole portion 351. The shaft portion 268 has an outer diameter smaller than the inner diameter of the small-diameter hole portion 351. The head portion 269 has an outer diameter larger than the inner diameter of the small-diameter hole portion 351 and smaller than the inner diameter of the larger-diameter hole portion 352.

As illustrated in FIG. 27, the right protrusion 267 of the first bumper 260 is inserted into the threaded boss 356a when the first bumper 260 is attached to the upper end portion 53a of the support rod portion 53. The outer diameter of the head portion 269 of the protrusion 267 is larger than the inner diameter of the small-diameter hole portion 351, but the head portion 269 can be inserted into the large-diameter hole portion 352 by being pushed in while being elastically deformed. At this time, the protrusion 267 is engaged with the inner surface defining the threaded boss 356a so as to be prevented from slipping off from the threaded boss 356a. The plurality of second protrusion portions 264 is engaged with the inner surfaces defining the plurality of recessed portions 238 so as to be prevented from slipping off from the plurality of recessed portions 238. More specifically, a stepped portion 353 is defined between the small-diameter hole portion 351 and the large-diameter hole portion 352 due to a difference between the inner diameters of the small-diameter hole portion 351 and the large-diameter hole portion 352. The right protrusion 267 is held in the threaded boss 356a due to the engagement of the head portion 269 of the protrusion 267 inserted in the large-diameter hole portion 352 with the stepped portion 353. The right wall portion 262a of the first bumper 260 is attached to the support rod portion 53 in this manner.

As illustrated in FIG. 27, a portion of the upper end portion 53a of the support rod portion 53 that corresponds to the second portion 250b includes a hole portion 355. The hole portion 355 is located at the same position as the threaded boss 356a in the up-down direction and the front-rear direction. The hole portion 355 includes a small-diameter hole portion 356 and a large-diameter hole portion 357. The small-diameter hole portion 356 has an inner diameter equal to the small-diameter hole portion 351, and the large-diameter hole portion 357 has an inner diameter equal to the large-diameter hole portion 352. The left protrusion 267 of the first bumper 260 is inserted into the hole portion 355 when the first bumper 260 is attached to the upper end portion 53a of the support rod portion 53. Due to that, the left protrusion 267 is held in the hole portion 355 in an engaged state, similarly to when the right protrusion 267 is inserted in the threaded boss 356a. The left wall portion 262b of the first bumper 260 is attached to the support rod portion 53 in this manner.

When the conventional impact wrench employs such an apparatus layout that the resin housing is located below the metallic casing, the protective cover cannot be engaged with the metallic casing at a portion where the resin housing is present. This case undesirably makes it easy for the protective cover to be detached from the metallic casing. Such a problem is not limited to an electric impact wrench, and is also applicable to various electric tools having a metallic casing, such as an impact driver and a shear wrench.

On the other hand, according to the above-described impact wrench 210, the first bumper 260 can be attached by inserting the first bumper 260 into the front portion of the hammer case 230 from the front side to engage the first engagement portion 263 of the first bumper 260 with the recessed portions 238 of the hammer case 230 and engage the second engagement portion 266 of the first bumper 260 with each of the threaded boss 356a and the hole portion 355 of the support rod portion 53 as indicated by the arrow AR1 in FIGS. 24 and 25. In other words, the first bumper 260 is attached due to the engagement of the first engagement portion 263 with the hammer case 230 and the engagement of the second engagement portion 266 with the support rod portion 53 which is adjacent to the hammer case 230 in the up-down direction. Therefore, the first bumper 260 can be prevented from unintentionally falling off compared with a configuration in which the first bumper 260 is engaged only with the hammer case 230. Further, the first bumper 260 can be detached by pulling the first bumper 260 in a disengagement direction with a strong force to elastically deform the first bumper 260.

Further, the first bumper 260 can be easily attached and detached by an operation of respectively pushing the pair of protrusions 267 of the second engagement portion 266 of the first bumper 260 into the threaded boss 356a and the hole portion 355 of the support rod portion 53, and an operation of pulling out them in the opposite direction. Further, because the stepped portions of the threaded boss 356a and the hole portion 355 are engaged with the head portions 269 of the protrusions 267, a robust engagement relationship can be established.

In addition, according to the impact wrench 210, the threaded boss 356a of the first portion 250a, which is provided for the purpose of joining the first portion 250a and the second portion 250b of the housing 250 together, is also usable as the hole portion for engaging the support rod portion 53 and the first bumper 260 (the protrusion portion 262). Therefore, the housing 250 (the first portion 250a) can be simply structured compared with when a hole portion like the hole portion 355 of the second portion 250b is provided separately from the threaded boss 356a for such engagement.

Further, according to the impact wrench 210, the second outer-diameter portion 234 of the hammer case 230 has an outer diameter smaller than the outer diameter of the first outer-diameter portion 233 (refer to FIG. 30). Therefore, in a state that the first bumper 260 is attached to the hammer case 230 with the plurality of second protrusion portions 264 of the first bumper 260 respectively inserted in the plurality of recessed portions 238 of the hammer case 230 (refer to FIG. 26), the annular portion 261 of the first bumper 260 is deeply fitted in the annular groove portion 235 between the first outer-diameter portion 233 and the second outer-diameter portion 234 and is sandwiched between the front side surface 233a of the first outer-diameter portion 233 and a rear side surface 234a of the second outer-diameter portion 234 in the front-rear direction even at a circumferential position where the second protrusion portion 264 is absent as illustrated in FIG. 23. Therefore, the engagement force is enhanced and the first bumper 260 can be further efficiently prevented from unintentionally falling off.

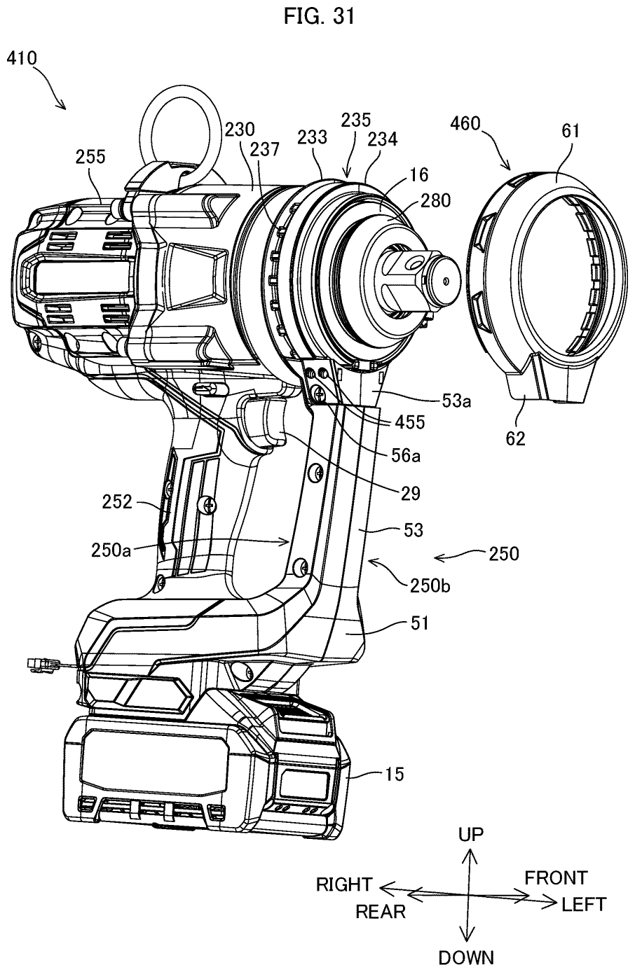

In the following description, an impact wrench 410 according to a fourth embodiment will be described with reference to FIGS. 31 to 33, focusing only on differences from the third embodiment. As illustrated in FIG. 31, the right surface of the upper end portion 53a of the support rod portion 53 of the impact wrench 410 includes two hole portions 455 above the threaded boss 56a located at the position corresponding to the threaded boss 356a according to the third embodiment. The left surface of the upper end portion 53a also includes two holes portions 455 at the same positions in the up-down direction and the front-rear direction as the right surface, although the illustration thereof is omitted here.

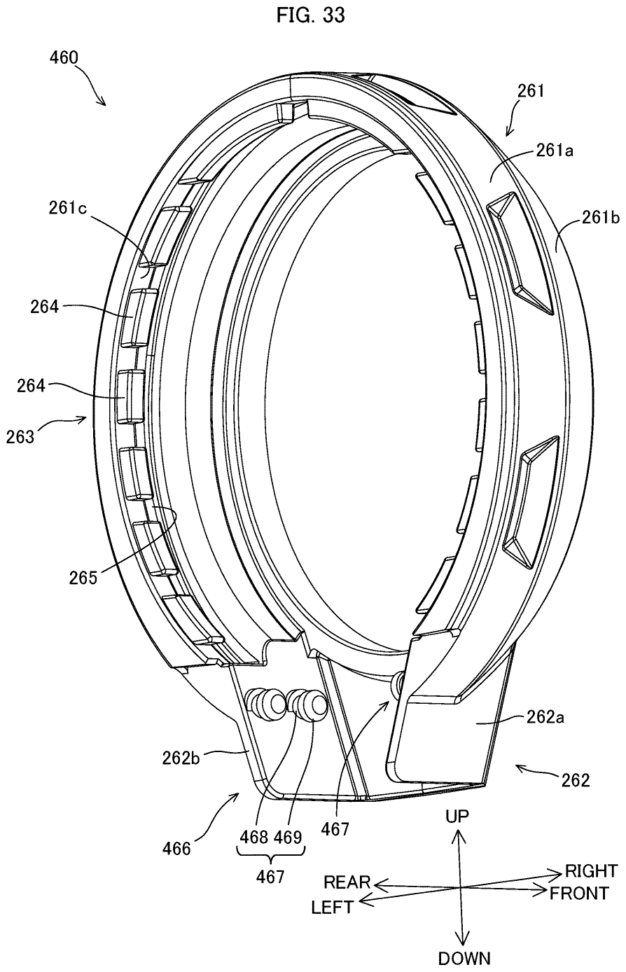

As illustrated in FIG. 33, the protrusion portion 262 of a first bumper 460 according to the fourth embodiment includes a second engagement portion 466 instead of the second engagement portion 266 according to the third embodiment. The second engagement portion 466 is detachably engaged with the housing 250 (more specifically, the upper end portion 53a of the support rod portion 53) using its elasticity. The second engagement portion 466 includes two protrusions 467 protruding from the inner surface of the left wall portion 262b rightward and two protrusions 467 protruding from the inner surface of the right wall portion 262a leftward. Each of the protrusions 467 includes a shaft portion 468 and a head portion 469 similarly to the shaft portion 268 and the head portion 269 of the protrusion 267 according to the third embodiment.

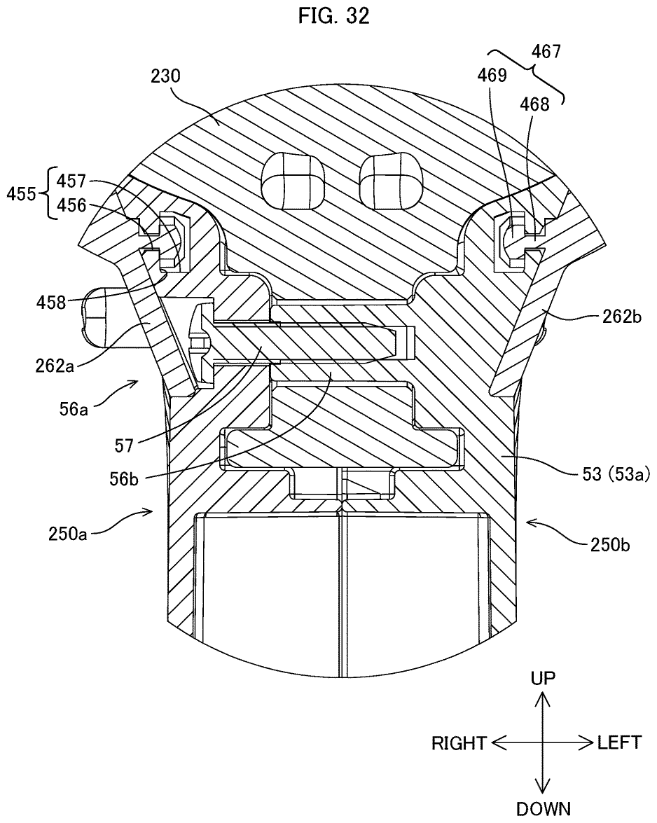

As illustrated in FIG. 32, each of the hole portions 455 includes a small-diameter hole portion 456 and a large-diameter hole portion 457 similarly to the small-diameter hole portion 356 and the large-diameter hole portion 357 according to the third embodiment. The head portion 469 of the protrusion 467 inserted in the large-diameter hole portion 457 is engaged with a stepped portion 458 between the small-diameter hole portion 456 and the large-diameter hole portion 457. The fourth embodiment configured in this manner can also achieve advantageous effects similar to the third embodiment.

The above-described third embodiment and fourth embodiment are intended to only facilitate the understanding of the present teaching, and are not intended to limit the present invention thereto. The present invention can be modified or improved without departing from the spirit thereof, and the present invention includes equivalents thereof. Further, each of the elements described in the claims and the specification can be combined in any manner or omitted in any manner within a range that allows it to remain capable of achieving at least a part of the above-described objects or bringing about at least a part of the above-described advantageous effects.

For example, the engagement structure between the hammer case 230 and the first engagement portion 263 of the first bumper 260 can be changed to any structure capable of providing engagement using the elasticity of the first engagement portion 263. Similarly, the engagement structure between the support rod portion 53 and the second engagement portion 266 of the first bumper 260 can be changed to any structure capable of providing engagement using the elasticity of the second engagement portion 266. For example, the engagement structure between the support rod portion 53 and the second engagement portion 266 may be changed to a configuration in which the support rod portion 53 includes a protrusion and the second engagement portion 266 includes a hole portion for inserting this protrusion.

Further, the resin housing 250 can be changed to any shape. In this case, the second engagement portion 266 of the first bumper 260 may be engaged with the housing 250 at an arbitrary position determined according to the shape of the resin housing 250 at a portion adjacent to the hammer case 230 in the up-down direction of the housing 250, instead of the support rod portion 53.

The above-described various embodiments are applicable to not only an impact wrench but also various electric tools having a metallic casing (for example, an impact driver and a shear wrench).

The present invention can also be realized in the following aspects.

### Aspect 1

An electric tool comprising:
a motor;
a final output shaft rotatable about a rotational axis;
a power transmission mechanism operably coupled with the motor and configured to transmit a rotational driving force of the motor to the final output shaft;
a metallic casing having a tubular shape extending in an axial direction, which is a direction in which the rotational axis extends, and containing a part of the final output shaft and at least a part of the power transmission mechanism therein;
a protective cover that is elastic and covers a portion of the metallic casing that is located on a front side around the rotational axis, the protective cover being detachably attached to the metallic casing from the front side, a front-rear direction being defined to be the axial direction and the front side and a rear side being defined to a side in the front-rear direction on which the final output shaft is located and a side opposite from the final output shaft, respectively; and
a resin housing located adjacent to the metallic casing in a direction orthogonal to the axial direction,
wherein the protective cover includes:
   an annular portion including a first engagement portion configured to be detachably engaged with the metallic casing using elasticity of the protective cover, the annular portion covering the metallic casing around the rotational axis; and
   a protrusion portion including a second engagement portion configured to be detachably engaged with the resin housing using the elasticity of the protective cover, the protrusion portion protruding from the annular portion radially outward.

### Aspect 2

The electric tool according to Aspect 1, wherein the resin housing includes a hole portion, and
the second engagement portion includes a protrusion inserted in the hole portion and engaged with an inner surface of the resin housing that defines the hole portion.

### Aspect 3

The electric tool according to Aspect 2, wherein the hole portion includes a small-diameter hole portion having a first inner diameter, and a large-diameter hole portion having a second inner diameter larger than the first inner diameter and continuous to the small-diameter hole portion on an inner side of the resin housing with respect to the small-diameter hole portion,
the protrusion includes a shaft portion having an outer diameter smaller than the first inner diameter, and a head portion having an outer diameter larger than the first inner diameter and smaller than the second inner diameter and located at a distal end of the shaft portion, and
the head portion of the protrusion that is inserted in the large-diameter hole portion is engaged with a stepped portion between the small-diameter hole portion and the large-diameter hole portion so as to be prevented from slipping off from the hole portion.

### Aspect 4

The electric tool according to Aspect 3, wherein the resin housing has a half-divided structure dividable into a first portion and a second portion, and
the hole portion includes a threaded boss in which a screw for joining the first portion and the second portion together is inserted.

### Aspect 5

The electric tool according to any one of Aspects 1 to 4, wherein the metallic casing includes a first outer-diameter portion having a first outer diameter, a second outer-diameter portion located on the front side with respect to the first outer-diameter portion and having a second outer diameter smaller than the first outer diameter, and an annular groove portion located between the first outer-diameter portion and the second outer-diameter portion,
the annular groove portion includes a bottom portion, a plurality of first protrusion portions protruding from the bottom portion radially outward and arranged at intervals along a circumferential direction,
a top portion of each of the first protrusion portions is located on a radially inner side with respect to an outer circumferential portion of the second outer-diameter portion,
the first engagement portion includes a plurality of second protrusion portions arranged at intervals in the circumferential direction, the plurality of second protrusion portions being respectively inserted in a plurality of recessed portions defined between the plurality of first protrusion portions in conformity therewith due to elastic deformation, and being engaged with inner surfaces defining the plurality of recessed portions so as to be prevented from slipping off from the plurality of recessed portions,
the annular portion is sandwiched between the first outer-diameter portion and the second outer-diameter portion in the front-rear direction with the plurality of second protrusion portions respectively inserted in the plurality of recessed portions.

### Aspect 6

The electric tool according to any one of Aspects 1 to 5, wherein the resin housing includes:
a battery holding portion configured to hold a detachable battery serving as a power source of the motor;
a handle located between the battery holding portion and the metallic casing in a direction orthogonal to the axial direction and extending elongatedly in a direction generally orthogonal to the axial direction; and
a support rod portion located on the front side with respect to the handle and extending elongatedly generally in parallel with the handle between the battery holding portion and the metallic casing, and
the second engagement portion is engaged with the support rod portion.

### DESCRIPTION OF THE REFERENCE NUMERALS

10 impact wrench
15 battery
16 illumination unit
21 motor
22 motor shaft
23 power transmission mechanism
24 speed reduction mechanism
25 spindle
26 impact mechanism
27 anvil
28 controller
29 trigger
30 hammer case
31 tubular portion
32 front protrusion portion
33 rear protrusion portion
34 threaded boss
35 screw
36 front base portion
37 front rib
38 upper surface
39 front second engagement portion
40 rear base portion
41 rear rib
42 upper surface
43 rear second engagement portion
50 housing
50a right portion
50b left portion
51 battery holding portion
51a battery mount portion
52 handle portion
52a upper end portion
53 support rod portion
53a upper end portion
54 coupling portion
55 motor containing portion
56a, 56b threaded boss
57 screw
58 gear case
59 side handle
60, 61 recessed portion
62, 63 upper inner surface
64 front first engagement portion
65, 66 recessed portion
67 inner surface
67, 68 upper inner surface
69 rear first engagement portion
90 first bumper
92 second bumper
110 impact wrench
130 hammer case
132 front protrusion portion
133 rear protrusion portion
136 front base portion
136a through-hole
137a upper rib
137b lower rib
138a, 138b upper surface
139a upper second engagement portion
139b lower second engagement portion
156a, 156b threaded boss
157 screw
160a, 160b, 161a, 161b recessed portion
162a, 162b, 163a, 163b upper inner surface
164a upper first engagement portion
164b lower first engagement portion
GR ground
AX1 rotational axis
210 impact wrench
230 hammer case
231 screw
232 annular recessed portion
233 first outer-diameter portion
233a front side surface
234 second outer-diameter portion
234a rear side surface
235 annular groove portion
236 bottom portion
237 first protrusion portion
237a top portion
237b side surface
238 recessed portion
250 housing
250a first portion
250b second portion
252 handle
255 motor housing
56a, 56b threaded boss
260 first bumper
261 annular portion
261a rear portion
261b front portion
261c inner circumferential surface
262 protrusion portion
262a right wall portion
262b left wall portion
262c front wall portion
263 first engagement portion
264 second protrusion portion
265 annular groove
266 second engagement portion
267 protrusion
268 shaft portion
269 head portion
280 second bumper
281 annular protrusion portion
351 small-diameter hole portion
352 large-diameter hole portion
353 stepped portion
355 hole portion
356 small-diameter hole portion
356a threaded boss
357 large-diameter hole portion
410 impact wrench
455 hole portion
456 small-diameter hole portion
457 large-diameter hole portion
478 stepped portion
460 first bumper
466 second engagement portion
467 protrusion
468 shaft portion
469 head portion

1. An electric tool comprising:
a motor;
a rotatable final output shaft;
a power transmission mechanism operably coupled with the motor and configured to transmit a rotational driving force of the motor to the final output shaft;
a resin housing including a motor containing portion, a battery holding portion, and a handle portion, the motor containing portion having a tubular shape extending in a front-rear direction and containing the motor therein, the battery holding portion holding a detachable battery serving as a power source of the motor, the handle portion extending elongatedly in a direction generally orthogonal to the front-rear direction between the motor containing portion and the battery holding portion, the front-rear direction being defined to be an axial direction of the final output shaft and a front side and a rear side being defined to a side in the front-rear direction on which the final output shaft is located and a side opposite from the final output shaft, respectively; and
a metallic casing located on the front side of the motor containing portion, the metallic casing including a tubular portion and a protrusion portion, the tubular portion having a tubular shape extending in the front-rear direction in communication with an inside of the motor containing portion, the tubular portion containing a part of the final output shaft and at least a part of the power transmission mechanism therein, the tubular portion being coupled with the motor containing portion by threaded joining, the protrusion portion protruding from the tubular portion radially outward,
wherein the protrusion portion includes a second engagement portion engaged with a first engagement portion of the resin housing on the front side with respect to a coupling position between the motor containing portion and the tubular portion, a up-down direction being defined to be a direction orthogonal to the front-rear direction and generally parallel with a longitudinal direction of the handle portion and an upper side and a lower side being defined to be a side in the up-down direction on which the motor containing portion is located and a side in the up-down direction on which the battery holding portion is located, respectively, the second engagement portion being located on the lower side with respect to the first engagement portion.

2. The electric tool according to claim 1, wherein the protrusion portion includes a base portion protruding from a lowest portion of the tubular portion downward, and an intersection-direction extending portion extending from the base portion in a direction intersecting with the up-down direction and including the second engagement portion.

3. The electric tool according to claim 2, wherein the intersection-direction extending portion extends in a direction orthogonal to the up-down direction, and
at least a part of an upper surface of the intersection-direction extending portion functions as the second engagement portion.

4. The electric tool according to claim 3, wherein the intersection-direction extending portion extends from the base portion rightward and leftward, a left-right direction being defined to be a direction orthogonal to the front-rear direction and the up-down direction,.

5. The electric tool according to claim 3, wherein the resin housing includes a recessed portion sized and shaped in conformity with the intersection-direction extending portion, the intersection-direction extending portion being contained in the recessed portion, and
at least a part of a surface facing downward, among inner surfaces of the resin housing that define the recessed portion, functions as the first engagement portion.

6. The electric tool according to claim 1, wherein the first engagement portion and the second engagement portion are engaged in surface contact with each other.

7. The electric tool according to claim 1, wherein the second engagement portion is located at a position corresponding to a front half of the metallic casing in the front-rear direction.

8. The electric tool according to claim 7, wherein the resin housing further includes a support rod portion located on the front side with respect to the handle portion and extending elongatedly generally in parallel with the handle portion between the battery holding portion and the metallic casing, and
the first engagement portion is located at a distal end portion of the support rod portion opposite from the battery holding portion.

9. The electric tool according to claim 1, wherein the first engagement portion includes a front first engagement portion and a rear first engagement portion, the rear first engagement portion being spaced apart from the front first engagement portion in the front-rear direction and located on the rear side with respect to the front first engagement portion, and
the second engagement portion includes a front second engagement portion and a rear second engagement portion, the front second engagement portion being engaged with the front first engagement portion, the rear second engagement portion being spaced apart from the front second engagement portion in the front-rear direction, located on the rear side with respect to the front second engagement portion, and engaged with the rear first engagement portion.

10. The electric tool according to claim 2, wherein the first engagement portion includes an upper first engagement portion and a lower first engagement portion, the lower first engagement portion being spaced apart from the upper first engagement portion in the up-down direction and located on the lower side with respect to the upper first engagement portion, and
the intersection-direction extending portion includes an upper second engagement portion and a lower second engagement portion, the upper second engagement portion being engaged with the upper first engagement portion, the lower second engagement portion being spaced apart from the upper second engagement portion in the up-down direction, located on the lower side with respect to the upper second engagement portion, and engaged with the lower first engagement portion.

11. The electric tool according to claim 1, wherein the resin housing has a half-divided structure dividable into a right portion and a left portion in a direction orthogonal to the front-rear direction and the up-down direction,
the electric tool includes a plurality of screws that join the right portion and the left portion together, and
each of the plurality of screws joins the right portion and the left portion together without penetrating through the protrusion portion.

12. The electric tool according to claim 1, wherein the resin housing has a half-divided structure dividable into a right portion and a left portion in a direction orthogonal to the front-rear direction and the up-down direction,
the electric tool includes a plurality of screws that join the right portion and the left portion together, and
at least one of the plurality of screws joins the right portion and the left portion together in a state of penetrating through the protrusion portion.

13. The electric tool according to claim 1, wherein the protrusion portion includes a base portion protruding from a lowest portion of the tubular portion downward, and an intersection-direction extending portion extending from the base portion in a direction intersecting with the up-down direction and including the second engagement portion,
the intersection-direction extending portion extends in a direction orthogonal to the up-down direction,
at least a part of an upper surface of the intersection-direction extending portion functions as the second engagement portion, and
the second engagement portion is located at a position corresponding to a front half of the metallic casing in the front-rear direction.

14. The electric tool according to claim 1, wherein the protrusion portion includes a base portion protruding from a lowest portion of the tubular portion downward, and an intersection-direction extending portion extending from the base portion in a direction intersecting with the up-down direction and including the second engagement portion,
the intersection-direction extending portion extends in a direction orthogonal to the up-down direction,
at least a part of an upper surface of the intersection-direction extending portion functions as the second engagement portion,
the second engagement portion is located at a position corresponding to a front half of the metallic casing in the front-rear direction,
the resin housing further includes a support rod portion located on the front side with respect to the handle portion and extending elongatedly generally in parallel with the handle portion between the battery holding portion and the metallic casing, and
the first engagement portion is located at a distal end portion of the support rod portion opposite from the battery holding portion.

15. The electric tool according to claim 1, wherein the protrusion portion includes a base portion protruding from a lowest portion of the tubular portion downward, and an intersection-direction extending portion extending from the base portion in a direction intersecting with the up-down direction and including the second engagement portion,
the intersection-direction extending portion extends in a direction orthogonal to the up-down direction,
at least a part of an upper surface of the intersection-direction extending portion functions as the second engagement portion,
the first engagement portion includes a front first engagement portion and a rear first engagement portion, the rear first engagement portion being spaced apart from the front first engagement portion in the front-rear direction and located on the rear side with respect to the front first engagement portion, and
the second engagement portion includes a front second engagement portion and a rear second engagement portion, the front second engagement portion being engaged with the front first engagement portion, the rear second engagement portion being spaced apart from the front second engagement portion in the front-rear direction, located on the rear side with respect to the front second engagement portion, and engaged with the rear first engagement portion.

16. The electric tool according to claim 1, wherein the protrusion portion includes a base portion protruding from a lowest portion of the tubular portion downward, and an intersection-direction extending portion extending from the base portion in a direction intersecting with the up-down direction and including the second engagement portion,
the intersection-direction extending portion extends in a direction orthogonal to the up-down direction,
at least a part of an upper surface of the intersection-direction extending portion functions as the second engagement portion,
the resin housing has a half-divided structure dividable into a right portion and a left portion in a direction orthogonal to the front-rear direction and the up-down direction,
the electric tool includes a plurality of screws that join the right portion and the left portion together, and
each of the plurality of screws joins the right portion and the left portion together without penetrating through the protrusion portion.

17. The electric tool according to claim 1, wherein the protrusion portion includes a base portion protruding from a lowest portion of the tubular portion downward, and an intersection-direction extending portion extending from the base portion in a direction intersecting with the up-down direction and including the second engagement portion,
the intersection-direction extending portion extends in a direction orthogonal to the up-down direction,
at least a part of an upper surface of the intersection-direction extending portion functions as the second engagement portion,
the resin housing has a half-divided structure dividable into a right portion and a left portion in a direction orthogonal to the front-rear direction and the up-down direction,
the electric tool includes a plurality of screws that join the right portion and the left portion together, and
at least one of the plurality of screws joins the right portion and the left portion together in a state of penetrating through the protrusion portion.
